(19) United States
(12) Patent Application Publication
(10) Pub. No.: US 2021/0387139 A1
(43) Pub. Date: Dec. 16, 2021

(54) ELECTROSWING ADSORPTION CELL WITH PATTERNED ELECTRODES FOR SEPARATION OF GAS COMPONENTS

(71) Applicant: Verdox, Inc., Woburn, MA (US)

(72) Inventors: Sahag VOSKIAN, Boston, MA (US); Karen THOMAS-ALYEA, Arlington, MA (US); Elizabeth Gerturde Burns, Windham, NH (US); Bhooshan C. Popere, Sturbridge, MA (US)

(21) Appl. No.: 17/345,074

(22) Filed: Jun. 11, 2021

Related U.S. Application Data
(60) Provisional application No. 63/128,358, filed on Dec. 21, 2020.
(60) Provisional application No. 63/037,829, filed on Jun. 11, 2020.

(51) Int. Cl. B01D 53/32; B01D 53/04; H01M 14/00; H01M 4/04; H01M 4/62; H01M 50/449; H01M 50/46

(52) U.S. Cl. CPC B01D 53/326; B01D 53/0454; H01M 14/00; H01M 2004/021; H01M 4/62; H01M 50/449; H01M 50/46; H01M 4/048

(57) ABSTRACT

The present disclosure relates to systems and electroswing adsorption cells with patterned electrodes. The patterned electrode includes a plurality of electrolyte regions, a plurality of gas regions and a conductive scaffold. The conductive scaffold extends into the plurality of electrolyte regions and includes an electroactive species. Methods for the manufacture of the electrode, the electroswing adsorption cell and gas separation systems including the electroswing adsorption cell are also described.

### CROSS-REFERENCE TO RELATED APPLICATIONS

This application claims priority to U.S. Provisional Application Nos. 63/037,829, filed Jun. 11, 2020, and 63/128,358, filed Dec. 21, 2020, the content of both of which are incorporated by reference herein in their entirety.

### BACKGROUND

Removing target species from gas mixtures has been the subject of much research and development. For example, there have been efforts to mitigate global warming by curbing carbon dioxide emissions. To this end a number of approaches have been explored, including conventional thermal methods, to capture carbon dioxide at different stages of its production. Other potential applications of target gas removal include removing target gases directly from air or ventilated air.

Electroswing adsorption (ESA) is an alternative method of capturing a target gas from a gaseous mixture. While ESA is an effective process for removing a target species from gas streams, the efficiency and productivity of the process can be limited by the speed at which gas species are able to diffuse into a sorbent electrode. In other words, the diffusion time constant of the gas species into the electrode can be a limiting factor in the ESA process.

Accordingly, there remains a need in the art for improved systems and electroswing adsorption cells for separation of gas components. It would be particularly advantageous to provide electroswing adsorption cells having patterned electrodes in order to address the above-described technical limitations of existing technologies.

### SUMMARY

Provided herein is a patterned electrode for an electroswing adsorption cell comprising: a plurality of electrolyte regions, a plurality of gas regions, and a conductive scaffold, the conductive scaffold extending into the plurality of electrolyte regions and including an electroactive species capable of bonding with a target gas when the electroactive species is in a reduced state and releasing the target gas when the electroactive species is in an oxidized state.

Also provided is an electroswing adsorption cell comprising the patterned electrode; a second electrode comprising a complementary electroactive composite layer; and a separator between the patterned electrode and the second electrode.

A method of producing the electroswing adsorption cell comprises depositing a composite material onto a separator, the composite material comprising an electrolyte and the conductive scaffold coated with the electroactive species; and forming the patterned electrode comprising the plurality of electrolyte regions and the plurality of gas regions; wherein forming the patterned electrode is by machining, lithography, etching, self-assembly, removal of a porogen or a combination thereof.

A method of producing an electroswing adsorption cell comprises depositing a composite material onto a separator, the composite material comprising an electrolyte and a conductive scaffold coated with an electroactive species; forming a patterned first electrode comprising a plurality of electrolyte regions and a plurality of gas regions; and coupling a gas flowfield and a second electrode to the patterned first electrode to provide the electroswing adsorption cell.

A method of producing an electroswing adsorption cell comprises providing a composite layer comprising an electrolyte and a first conductive scaffold coated with an electroactive species; providing a second conductive scaffold comprising gas-filled pores; pleating the composite layer with the second composite layer to provide a patterned first electrode; and coupling a gas flowfield and a second electrode to the patterned first electrode to provide the electroswing adsorption cell.

A gas separation system comprises a plurality of electroswing adsorption cells in fluid communication with a gas inlet and a gas outlet, wherein each of the plurality of electroswing adsorption cells is according to the present disclosure.

The above described and other features are exemplified by the following figures and detailed description

### BRIEF DESCRIPTION OF THE DRAWINGS

FIG. 1A is a schematic diagram of an asymmetric electrochemical swing adsorption cell with a patterned electrode.

FIG. 1B is a schematic diagram of a symmetric electrochemical swing adsorption cell with a patterned electrode.

FIG. 2A is a schematic illustration of an electrochemical swing adsorption cell with a patterned electrode.

FIG. 2B is a schematic illustration of the particles which comprise the conductive scaffold.

FIG. 2C is a schematic illustration of the particles of the conductive scaffold 220 comprising small particles 224 disposed upon larger fibers 222.

FIG. 2D is a schematic illustration of a gas flowfield.

FIG. 2E is a schematic illustration of a gas flowfield.

FIG. 3 is a side view of an electrochemical swing adsorption cell with a patterned electrode.

FIG. 4 is a front view of a patterned electrode.

FIG. 5 is a side view of an electrochemical swing adsorption cell with a patterned electrode.

FIG. 6 is a side view of a patterned electrode.

FIG. 7 is a side view of an electrochemical swing adsorption cell with a patterned electrode.

FIG. 8 is a front view of a patterned electrode.

FIG. 9 is a side view of an electrochemical swing adsorption cell with a patterned electrode.

FIG. 10 is a front view of a patterned electrode.

FIG. 11 is a perspective of an electrochemical swing adsorption cell.

FIG. 12 is a side view of an electrochemical swing adsorption cell with a patterned electrode.

FIG. 13 is a side view of an electrochemical swing adsorption cell with patterned electrode-separator assembly.

FIG. 14 shows a method of forming an electrochemical swing adsorption cell.

FIG. 15 shows a method of forming an electrochemical swing adsorption cell.

FIG. 16 shows a method of forming an electrochemical swing adsorption cell.

FIG. 17 shows a method of forming an electrochemical swing adsorption cell.

FIG. 18 shows simulated concentration of Lewis acid gas in an electrochemical swing adsorption cell.

FIG. 19 shows the simulated flux into a patterned electrode for different electrode thicknesses (millimeters, mm), air flow rates, and gas region thicknesses.

FIG. 20 shows a chemical scheme for the synthesis of a polymeric ionic liquid according to synthesis examples 1 and 2.

FIG. 21 shows a graph of pressure drop and cell voltage vs. time, indicative of CO₂ capture in an electroswing adsorption cell according to example 3 with 10% CO₂ in N₂.

### DETAILED DESCRIPTION

Systems and electroswing adsorption cells with patterned electrodes for separation of gas components are described herein. Systems that employ an electroswing adsorption (ESA) process have several technical potential advantages. ESA systems can remove carbon dioxide or other Lewis acids from air and deposit it into a different location (e.g., a greenhouse). ESA includes application of a first potential (e.g., a cathodic potential) to an electroactive species (denoted as “P” below), resulting in a reduction of the electroactive species P. The reduced electroactive species P⁻ can bind with a Lewis acid gas G dissolved in an adjacent electrolyte solution. The cation (denoted as “C⁺” below) is incorporated from the adjacent electrolyte solution to balance the charge in the electroactive species P.

P+e⁻+C⁺+G [symbol] P⁻·C⁺·G

The ESA process can be reversed upon application of a second potential (e.g., an anodic potential, when the first potential is a cathodic potential). The interfacial contact area between the electroactive species P and the electrolyte can be made large by coating the electroactive species onto a porous, high-surface area, electronically conductive scaffold (e.g., carbon fiber paper, carbon nanotube coated carbon fiber). Examples of applications of ESA apparatus and methods of preparing the same are described in U.S. Pat. No. 10,464,018, the entire disclosure of which is hereby incorporated by reference herein in its entirety for all purposes.

The pores of the electronically conductive scaffold can be filled with an electrolyte. The diffusion length L_{D} of a path the Lewis acid gas G follows to diffuse from a gas region through the electrolyte to an active site of the electroactive species P in an ESA cell can affect the diffusion time constant of the Lewis acid gas G. In addition, the length L_{I} is the distance the cation C⁺ migrates from the separator to the active site of the electroactive species P in an ESA cell. A high L_{D} value can limit the rate of diffusion of G, thereby limiting the capture rate of the device. Also, a high L_{I} value can increase the internal resistance in the ESA cell.

In an ESA configuration that includes only electrolyte-filled regions in the electronically conductive scaffold, L_{D} and L_{I} are both equal to the thickness of the electrode material.

An amount of the electroactive species P per unit area of the electroswing adsorption cell is proportional to the thickness of the electrode material. The present inventors have unexpectedly found that by incorporating gas-filled regions into the electrode (e.g., by forming a patterned electrode), gas-filled regions can extend beyond the gas flowfield into the electrode material. In other words, L_{D} can be measured from points within the electrode (e.g., the distance between gas-filled regions), rather than from the interface between the gas flowfield and the electrode. Diffusivity of gas is higher through a gas phase than when the gas is dissolved in the liquid electrolyte. It is therefore advantageous for the Lewis acid gas G to travel as much as possible through the gas phase en route to the active site of the electroactive species P. The incorporation of gas-filled regions into the electrode material can thus effectively reduce the value of L_{D}. Geometries that can reduce L_{D}, while maintaining or possibly increasing L_{I} are therefore desirable. Reducing L_{D} can reduce the diffusion time constant of the Lewis acid gas G while increasing or maintaining the amount of electroactive species P per unit area of the electroswing adsorption cell. In other words, modifying the physical structure of the electrode into which the gas species migrates can reduce the diffusion time constant of the gas species into the electrode. The reduction of the diffusion time constant can improve performance of the ESA system. Modifying the physical structure of the electrode can also increase the amount of the electroactive species P per unit area of the electro swing adsorption cell. Higher amounts of electroactive species P per unit area can reduce the cost of implementing such an electroswing adsorption cell.

Accordingly, an aspect of the present disclosure is an electroswing adsorption cell comprising a first electrode comprising a plurality of electrolyte regions, a plurality of gas regions, and a conductive scaffold, the conductive scaffold extending into the plurality of electrolyte regions and including an electroactive species. The electroswing adsorption cell of the present disclosure can also be referred to herein as an “electrochemical swing adsorption cell” or an “electrochemical cell” or “the cell”. The first electrode comprising the plurality of electrolyte regions, the plurality of gas regions, and the conductive scaffold can also be referred to as a “patterned first electrode” for brevity. The term “patterned” as used herein can refer to a regular or irregular configuration of the gas regions of the electrode. The gas regions can be provided in an ordered, predictable, or regular configuration, or can be provided in an irregular, random, or unpredictable configuration. When the pattern is an irregular pattern, the first electrode can also be referred to as “inhomogeneous,” wherein the gas regions are dispersed unpredictably throughout the electrode and may have any suitable size and shape. The arrangement and shape of the gas regions, and thus the “pattern” of the first electrode, is further described herein.

The electroswing adsorption cell can also further comprise a second electrode comprising a complementary electroactive composite layer; and a separator between the patterned first electrode and the second electrode.

The patterned first electrode comprises the conductive scaffold and the electroactive species. The conductive scaffold can comprise a carbonaceous material or a metal. In an aspect, the conductive scaffold comprises a carbonaceous material. Exemplary carbonaceous materials can include, but are not limited to, carbon paper (treated, PTFE-treated, or untreated), carbon cloth, nonwoven carbon mat, carbon black, carbon fibers, carbon nanotubes (including multi-walled and single-walled carbon nanotubes), a nonwoven carbon nanotube mat, flake graphite, graphene, and the like (e.g., other nanostructured carbon materials), or a combination thereof.

In an aspect, the conductive scaffold can comprise a fibrous material, for example a fibrous carbonaceous material. When present, the fibers can have an ordered arrangement as in a woven material, (e.g., the conductive scaffold can comprise fibers arranged parallel to each other along an x-axis, a y-axis, or a z-axis, forming an ordered network). In an aspect, fibers of the conductive scaffold can be dispersed throughout the patterned first electrode in a random configuration. In an aspect, the conductive scaffold can have an ordered arrangement in some portions of the patterned electrode and in a random configuration in other portions of the patterned electrode.

In an aspect, the conductive scaffold can include carbon fibers with an average diameter of 0.1 to 20 μm. Within this range, the average diameter can be at least 0.1 μm, at least 0.2 μm, at least 0.3 μm, at least 0.4 μm, at least 0.5 μm, at least 0.6 μm, at least 0.7 μm, at least 0.8 μm, at least 0.9 μm, at least 1 μm, at least 2 μm, at least 3 μm, at least 4 μm, at least 5 μm, at least 6 μm, at least 7 μm, at least 8 μm, at least 9 μm, at least 10 μm, at least 11 μm, at least 12 μm, at least 13 μm, at least 14 μm, at least 15 μm, at least 16 μm, at least 17 μm, at least 18 μm, or at least 19 μm. Also within this range, the average diameter can be no more than 20 μm, no more than 19 μm, no more than 19 μm, no more than 18 μm, no more than 17 μm, no more than 16 μm, no more than 15 μm, no more than 14 μm, no more than 13 μm, no more than 12 μm, no more than 11 μm, no more than 10 μm, no more than 9 μm, no more than 8 μm, no more than 7 μm, no more than 6 μm, no more than 5 μm, no more than 4 μm, no more than 3 μm, no more than 2 μm, no more than 1 μm, no more than 0.9 μm, no more than 0.8 μm, no more than 0.7 μm, no more than 0.6 μm, no more than 0.5 μm, no more than 0.4 μm, no more than 0.3 μm, or no more than 0.2 μm. Combinations of the above-referenced average diameters for the carbon fibers are also possible.

In an aspect, the conductive scaffold can include carbon nanotubes with an average diameter of 0.4 to 40 nm. Within this range, the carbon nanotubes can have an average diameter of at least 0.4 nm, at least 0.5 nm, at least 0.6 nm, at least 0.7 nm, at least 0.8 nm, at least 0.9 nm, at least 1 nm, at least 2 nm, at least 3 nm, at least 4 nm, at least 5 nm, at least 6 nm, at least 7 nm, at least 8 nm, at least 9 nm, at least 10 nm, at least 15 nm, at least 20 nm, at least 25 nm, at least 30 nm, or at least 35 nm. Also within this range, the carbon nanotubes can have an average diameter of no more than 40 nm, no more than 35 nm, no more than 30 nm, no more than 25 nm, no more than 20 nm, no more than 15 nm, no more than 10 nm, no more than 9 nm, no more than 8 nm, no more than 7 nm, no more than 6 nm, no more than 5 nm, no more than 4 nm, no more than 3 nm, no more than 2 nm, no more than 1 nm, no more than 0.9 nm, no more than 0.8 nm, no more than 0.7 nm, no more than 0.6 nm, or no more than 0.5 nm. Combinations of the above-referenced average diameters for the carbon nanotubes are also possible.

In an aspect, the conductive scaffold can include carbon nanotubes with an average length of 1 μm to 1 mm. Within this range, the carbon nanotubes can have an average length of at least 1 μm, at least 2 μm, at least 3 μm, at least 4 μm, at least 5 μm, at least 6 μm, at least 7 μm, at least 8 μm, at least 9 μm, at least 10 μm, at least 20 μm, at least 30 μm, at least 40 μm, at least 50 μm, at least 60 μm, at least 70 μm, at least 80 μm, at least 90 μm, at least 100 μm, at least 200 μm, at least 300 μm, at least 400 μm, at least 500 μm, at least 600 μm, at least 700 μm, at least 800 μm, at least 900 μm, or at least 1 mm. Also within this range, the carbon nanotubes can have an average length of no more than 1 mm, no more than 900 μm, no more than 800 μm, no more than 700 μm, no more than 600 μm, no more than 500 μm, no more than 400 μm, no more than 300 μm, no more than 200 μm, no more than 100 μm, no more than 90 μm, no more than 80 μm, no more than 70 μm, no more than 60 μm, no more than 50 μm, no more than 40 μm, no more than 30 μm, no more than 20 μm, no more than 10 μm, no more than 9 μm, no more than 8 μm, no more than 7 μm, no more than 6 μm, or no more than 5 μm. Combinations of the above-referenced average lengths for the carbon nanotubes are also possible.

In an aspect, the conductive scaffold can include vapor-grown carbon fibers having an average diameter of 100 to 200 nm. Within this range, the vapor-grown carbon fibers can have an average diameter of at least 100 nm, at least 110 nm, at least 120 nm, at least 130 nm, at least 140 nm, at least 150 nm, at least 160 nm, at least 170 nm, at least 180 nm, or at least 190 nm. Also within this range, the vapor-grown carbon fibers can have an average diameter of no more than 200 nm, no more than 190 nm, no more than 180 nm, no more than 170 nm, no more than 160 nm, no more than 150 nm, no more than 140 nm, no more than 130 nm, no more than 120 nm, or no more than 110 nm. Combinations of the above-referenced average diameters for the vapor-grown carbon fibers are also possible.

In an aspect, the carbon nanotubes of the conductive scaffold are multi-walled nanotubes having an average diameter of 15 nm to 50 nm. Within this range, the multi-walled nanotubes can have an average diameter of at least 15 nm, at least 20 nm, at least 25 nm, at least 30 nm, at least 35 nm, at least 40 nm, or at least 45 nm. Also within this range, the multi-walled nanotubes can have an average diameter of no more than 50 nm, no more than 45 nm, no more than 40 nm, no more than 35 nm, no more than 30 nm, no more than 25 nm, or no more than 20 nm. Combinations of the above-referenced average diameters for the multi-walled nanotubes are also possible.

In an aspect, the conductive scaffold can comprise conductive carbon black. Examples of suitable materials include Ketjen black products commercially available from Nouryon, Super P™ commercially available from Imerys, or LITX™ products commercially available from Cabot Corporation.

In an aspect, the conductive scaffold can comprise a metal or alloy which can include, but is not limited to, iron, nickel, aluminum, titanium, zinc, magnesium, copper, an alloy thereof, or a combination thereof.

In an aspect, the conductive scaffold can comprise metal nanowires. Exemplary metal nanowires can include, but are not limited to, silver nanowires.

In an aspect, the conductive scaffold can be a composite material comprising a structural scaffold and a conductive polymer, for example wherein the conductive polymer is disposed on at least a portion of the structural scaffold. The structural scaffold can comprise, for example, cellulose nanofibers. The cellulose nanofibers can optionally include various functional groups on the surface of the fiber, for example hydroxyl groups, carboxyl groups, (2,2,6,6-Tetramethylpiperidin-1-yl)oxyl (TEMPO) groups, or a combination thereof. Examples of suitable conductive polymers can include, but are not limited to poly(thiophene), poly(alkylthiophene), poly(3,4-dialkoxythiophene), poly(pyrrole), poly(aniline), and the like, or a combination thereof. In an aspect, the conductive polymer can comprise a blend of poly(3,4-ethylenedioxythiophene) and poly(styrenesulfonate) sodium salt (PEDOT-PSS). It will be understood that, when present, the aforementioned conductive polymers can be doped (e.g., chemically oxidized or reduced) to provide the desired conductivity. Suitable dopants and methods for doping the conductive polymers can be readily determined by the skilled person.

In an aspect, the conductive scaffold can comprise a mixture of any of the foregoing. For example, the conductive scaffold can comprise a mixture of at least two of the carbon nanotubes, conductive carbon black, the metal nanowires, or the composite comprising a structural scaffold and a conductive polymer.

The conductive scaffold may have any suitable electrical conductivity, e.g., an electronic conductivity of 1×10⁻³ to 1×10⁴ S/cm, or 1×10⁻² to 1×10³ S/cm. The electrical conductivity can be determined at 20° C. according to ASTM B-193, “Standard Test Method for Resistivity of Electrical Conductor Materials.”

The electroactive species can be disposed on the conductive scaffold. The electroactive species can be disposed on at least a portion of a surface of the conductive scaffold. In an aspect, the conductive scaffold can be impregnated with the electroactive species. In an aspect, one or more intervening layers can be positioned between a surface of the conductive scaffold and the electroactive species. In an aspect, no intervening layers are present, and the electroactive species can be disposed directly on a surface of the conductive scaffold. The electroactive species can form a monolayer on a surface of the conductive scaffold (e.g., a molecular or oligomeric or polymeric monolayer). Alternatively, the electroactive species can form a layer disposed on a surface of the conductive scaffold having a thickness of, for example, 0.5 to 100 nanometers. Within this range, the electroactive species layer thickness can be at least 1 nanometer or at least 5 nanometers or at least 10 nanometers. Also within this range, the electroactive species layer thickness can be at most 90 nanometers, or at most 80 nanometers, or at most 70 nanometers, or at most 60 nanometers, or at most 50 nanometers, or at most 40 nanometers, or at most 30 nanometers or at most 20 nanometers, or at most 10 nanometers.

The electroactive species can be referred to as being immobilized on the conductive scaffold such that the electroactive species is not capable of freely diffusing away from or dissociating from the conductive scaffold. The electroactive species can be immobilized on the conductive scaffold in a variety of ways. For example, the electroactive species can be immobilized on the conductive scaffold by being bound (e.g., via covalent bonds, ionic bonds, or intramolecular interaction such as electrostatic forces, van der Waals forces, hydrogen bonding, or a combination thereof) to the surface of the conductive scaffold. In an aspect, the electroactive species can be immobilized on the conductive scaffold by being adsorbed onto a surface of the conductive scaffold. In an aspect, the electroactive species can be immobilized on the conductive scaffold. Immobilizing the electroactive species can include, but is not limited to, grafting or polymerizing the electroactive species onto a surface of the conductive scaffold. “Grafting” as used herein refers to a chemical or electrochemical process producing a covalent bond between the electroactive species and the conductive scaffold. In an aspect, the electroactive species can be immobilized on the conductive scaffold by being included in a composition, e.g., a coating or a composite layer that is applied or deposited onto the conductive scaffold. Immobilizing the electroactive species can also include electrodeposition, plasma deposition, vacuum infiltration, melt coating, or a combination of any of the foregoing.

As used herein, an “electroactive species” refers to an agent (e.g., a chemical entity) which undergoes oxidation or reduction upon exposure to an electrical potential in an electroswing adsorption cell. The electroactive species of the composite is capable of bonding with or binding to a target gas when the electroactive species is in a particular oxidation state, for example a reduced state, and releasing the target gas when the electroactive species is in a second oxidation state, for example an oxidized state. As a non-limiting example, in an aspect, the electroactive species can be reduced to a corresponding reduced state, which binds to the target gas forming a complex or an adduct. Subsequent oxidation of the electroactive species can release the target gas. In particular, as a non-limiting example, if the electroactive species is benzoquinone, the neutral benzoquinone would be considered the oxidized state, the semiquinone (e.g., a product of the addition of one electron to neutral benzoquinone) would be considered a first reduced state, and the benzoquinone dianion (the product of the addition of one electron to the semiquinone) would be considered a second reduced state.

The electroactive species of the composite can be selected such that in at least one oxidation state, the electroactive species can have a strong affinity for the target gas. In an aspect, in at least one oxidation state, the electroactive species can have a binding constant with the target gas of at least 10¹ liters/mole (M⁻¹), or at least 10² M⁻¹, or at least 10³ M⁻¹ at room temperature (e.g. 23° C.). Within this range, the electroactive species can have a binding constant with the target gas of 10¹ to 10²⁰ M⁻¹, 10³ to 10¹⁹ M⁻¹, 10⁴ to 10¹⁸ M⁻¹, 10⁵ to 10¹⁷ M⁻¹, 10⁶ to 10¹⁶ M⁻¹, or 10⁷ to 10¹⁵ M⁻¹. In an aspect, the binding constant with the target gas is 10⁵ to 10²⁰ M⁻¹, or 10¹⁰ to 10¹⁵ M⁻¹. In an aspect, the target gas can be carbon dioxide (CO₂), and the electroactive species (in a reduced state) can have a binding constant with the CO₂ of 10¹ to 10¹⁵. In an aspect, the target gas can be sulfur dioxide (SO₂), and the electroactive species (in a reduced state) can have a binding constant with the SO₂ of 10⁵ to 10²⁰.

In an aspect, the electroactive species can have at least two oxidation states. When the electroactive species is in a first oxidation state, it can be considered to be in an “active state,” wherein the affinity for the target gas can be high (e.g., the electroactive species in the “active state” can have a binding constant with the target gas as defined above). In a second oxidation state, the electroactive species can be considered to be in a “deactivated” state, wherein the affinity for the target gas is reduced relative to the affinity for the target gas of the “active” state. For example, the electroactive species can have a ratio of the binding constant in the deactivated state to the binding constant in the active state of 0.9:1 to 10⁻²⁰:1, for example, 0.9:1, 0.8:1, 0.5:1, 0.1:1, 10⁻²:1, 10⁻³:1, 10⁻⁴:1, or 10⁻⁵:1 to 10⁻²⁰:1. In an aspect, the binding constant with the target gas in the deactivated state can be 0, that is the deactivated state is essentially inactive towards the target gas species.

The electroactive species can have at least one oxidation state wherein the target gas can be released from the electroactive species. For example, in an aspect, the electroactive species can have at least one oxidized state, wherein upon oxidation to the oxidized state, the target gas can be released from the electroactive species. In an aspect, the binding constant of the reduced electroactive species can be greater than the binding constant of the corresponding oxidized electroactive species. Accordingly, in an advantageous feature, capture and release of the target gas can be achieved through redox cycling.

The electroactive species can be capable of binding the target gas on a timescale on the order of minutes, on the order of seconds, on the order of milliseconds, or on the order of microseconds or less.

In an aspect, the electroactive species can have at least one oxidation state (e.g., a reduced state) in which the electroactive species is capable of bonding with the target gas, but for which there is at least one temperature (e.g., in a range of greater than or equal to 223 K, greater than or equal to 248 K, greater than or equal to 273 K, or greater than or equal to 298 K, and up to 323 K, up to 348 K, or up to 413 K, for example 298 K) at which it is thermodynamically unfavorable for the electroactive species to react with oxygen (O₂). In an aspect, the electroactive species can have a reduced state in which the electroactive species is capable of bonding with the target gas, but for which there is at least one temperature (e.g., 298 K) at which it is kinetically unfavorable for the electroactive species to react with oxygen (O₂) because a rate, e.g., rate constant, for the reaction with oxygen is too slow for a reaction to occur on a timescale commensurate with capture of the target gas. Accordingly, the electroactive species of the composite effectively provides a suitable specificity towards capture of the target gas.

The electroactive species of the composite can comprise an electroactive organic compound, an electroactive polymer, an electroactive oligomer, or a combination thereof. The electroactive species can include at least one functional group capable of binding to a target gas, for example a carbonyl group.

Exemplary electroactive organic compounds can include, but are not limited to, a substituted or unsubstituted quinone or tetrone. In an aspect, the electroactive species comprises a substituted or unsubstituted quinone (e.g., the quinone can include one or more functional groups or other moieties or linkages bound to the quinone). The choice of substituent (e.g., functional groups) on the substituted quinone can depend on a variety of factors, including but not limited to its effect on the reduction potential of the substituted quinone. One of ordinary skill, with the benefit of this disclosure, would understand how to determine which substituents or combinations of substituents on the substituted quinone are suitable for the first electroactive species based on, for example synthetic feasibility and resulting reduction potential. Exemplary functional groups can include, but are not limited to, halo (e.g., chloro, bromo, iodo), hydroxyl, carboxylate/carboxylic acid, sulfonate/sulfonic acid, alkylsulfonate/alkylsulfonic acid (e.g., C₁₋₁₈ alkylsulfonate), phosphonate/phosphonic acid, alkylphosphonate/alkylphosphonic acid (e.g., C₁₋₁₈ alkylphosphonate), acyl (e.g., acetyl or ethyl ester), amino, amido, quaternary ammonium (e.g., tetraalkylamino), branched or unbranched alkyl (e.g., C₁₋₁₈ alkyl), heteroalkyl, alkoxy, glycoxy, polyalkyleneglycoxy (e.g., polyethyleneglycoxy), imino, polyimino, branched or unbranched alkenyl (e.g., C₂₋₁₈ alkenyl), branched or unbranched, C₂₋₁₈ alkynyl, C₆₋₃₀ aryl, C₄₋₂₀ heteroaryl, heterocyclyl, nitro, nitrile, thiyl, or carbonyl groups, any of which can be substituted or unsubstituted. Any suitable organic or inorganic counterion can be present in the foregoing charged species, for example an alkali metal, alkaline earth metal, ammonium, or a substituted ammonium of the formula R₄N⁺ wherein each R is the same or different, and is independently a C₁₋₁₈ hydrocarbyl, provided that at least one R is hydrocarbyl.

In an aspect, the electroactive species comprises a substituted or unsubstituted quinone of structure (I) or (II):

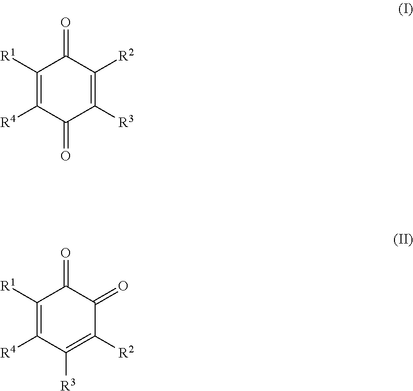

wherein R¹, R², R³, and R⁴ are independently at each occurrence hydrogen, halogen (e.g., chloro, bromo, iodo), hydroxyl, carboxylate/carboxylic acid, sulfonate/sulfonic acid, alkylsulfonate/alkylsulfonic acid (e.g., C₁₋₁₈ alkylsulfonate), phosphonate/phosphonic acid, alkylphosphonate/alkylphosphonic acid (e.g., C₁₋₁₈ alkylphosphonate), acyl (e.g., acetyl or ethyl ester), amino, amido, quaternary ammonium (e.g., tetraalkylamino), branched or unbranched C₁₋₁₈ alkyl, C₁₋₁₈ heteroalkyl, C₁₋₁₈ alkoxy, glycoxy, polyalkyleneglycoxy (e.g., polyethyleneglycoxy), imino, polyimino, branched or unbranched alkenyl, branched or unbranched C₂₋₁₈ alkynyl, C₆₋₂₀ aryl, C₄₋₂₀ heteroaryl, heterocyclyl, nitro, nitrile, thiyl, or carbonyl groups, any of which can be substituted or unsubstituted, and any two adjacent R¹-R⁴ groups can optionally join together to form a cyclic group.

In an aspect, the electroactive organic compound can comprise a quinone, here defined as a cyclic, conjugated system having an even number of carbonyl groups that can be reduced in the manner shown below to form the corresponding aromatic species.

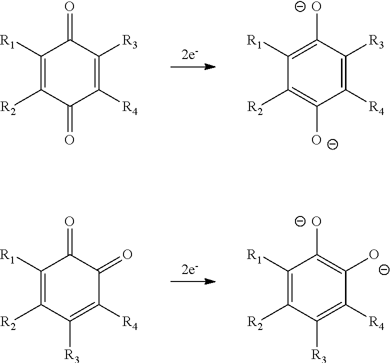

These include derivatives of 1,4-benzoquinone, 1,2-benzoquinone, naphthoquinone, anthraquinone, phenanthrenequinone, benzanthraquinone, dibenzoanthraquinone, 4,5,9,10-pyrenetetrone, or a combination thereof. Any of the foregoing can optionally be substituted as described above. In an aspect, the electroactive organic compound is a substituted or unsubstituted naphthoquinone. Other regioisomers of the foregoing non-limiting exemplary electroactive organic compounds can also be used (e.g., with substituents at different positions of the quinone).

In an aspect, the electroactive species comprises the electroactive polymer. As used herein, the term “polymer” refers to structures having greater than 10 repeating units. For example, an electroactive polymer can comprise repeating units including any of the foregoing electroactive organic compounds. Suitable electroactive polymers can include, for example, those comprising repeating units derived from a substituted or unsubstituted quinone. In an aspect, at least a portion of the electroactive polymer comprises a polymer backbone wherein at least one of the electroactive organic compounds is covalently bound to the polymer backbone. In an aspect, the electroactive organic compounds can form at least a portion of the polymer backbone.

In an aspect, the electroactive polymer comprises repeating units derived from a quinone, which as described above can include 1,4-benzoquinone, 1,2-benzoquinone, naphthoquinone, anthraquinone, phenanthrenequinone, benzanthraquinone, dibenzoanthraquinone, 4,5,9,10-pyrenetetrone, or a combination thereof.

In an aspect, the electroactive polymer can comprise substituted or unsubstituted poly(anthraquinone). In an aspect, the electroactive polymer can comprise a substituted or unsubstituted poly(vinyl anthraquinone). In an aspect, the electroactive polymer can comprise a substituted or unsubstituted poly(phenylnaphthoquinone).

In an aspect, the electroactive species comprises the electroactive oligomer. As used herein, the term “oligomer” refers to structures having 2 to 10 repeating units. The electroactive oligomer can accordingly have any structure as described for the electroactive polymer, except that it is limited to 10 repeat units or less. For example, suitable electroactive oligomers can include those comprising repeating units derived from a substituted or unsubstituted quinone, preferably an oligomer comprising repeating units derived from 1,4-benzoquinone, 1,2-benzoquinone, naphthoquinone, anthraquinone, phenanthrenequinone, benzanthraquinone, dibenzoanthraquinone, 4,5,9,10-pyrenetetrone, or a combination thereof. In an aspect, the electroactive oligomer can comprise oligo(anthraquinone). In an aspect, the electroactive oligomer can comprise an oligo(vinyl anthraquinone). In an aspect, the electroactive oligomer can comprise a substituted or unsubstituted oligo(phenylnaphthoquinone).

When the electroactive species comprises the electroactive polymer or the electroactive oligomer, the electroactive polymer or the electroactive oligomer can optionally be crosslinked. Crosslinking can be effected by various methods known in the art. The skilled person, with the benefit of this disclosure, would be able to determine a suitable crosslinking chemistry based on the selection of the electroactive species.

The thickness of the electroactive species on the surface of the conductive scaffold can be, for example, 0.1 to 20 nanometers, or 0.2 to 15 nanometers, or 0.5 to 10 nanometers. The thickness of the electroactive species on the surface of the conductive scaffold can depend on the mode of deposition.

The electroactive species can be present in an amount of 10 to 90 mass percent, based on the mass of electroactive species and conductive scaffold in the patterned first electrode. Within this range, the electroactive species can be present in an amount of at least 20 mass percent, or at least 25 mass percent, or at least 30 mass percent, or least 40 mass percent, or at least 50 mass percent, based on the mass of electroactive species and conductive scaffold in the first electrode. Also within this range, the electroactive species can be present in an amount of at most 80 mass percent, or at most 70 mass percent, or at most 60 mass percent, or at most 50 mass percent, or at most 45 mass percent, or at most 40 mass percent. For example, the electroactive species can be present in an amount of 10 to 75 mass percent, or 10 to 60 mass percent, or 15 to 60 mass percent, or 20 to 55 mass percent, or 25 to 55 mass percent, or 30 to 50 mass percent, based on the mass of electroactive species and conductive scaffold in the patterned first electrode.

The electroactive species and the conductive scaffold can be present in a mass ratio of 1:10 to 10:1, or 1:5 to 5:1, or 1:10 to 1:1.

The electroactive species is reactive toward a target gas. The target gas is an electrophilic molecule. In an aspect, the target gas is a Lewis acid gas. The target gas is capable of forming a complex or an adduct with the electroactive species of the composite when the electroactive species is in a reduced state, for example, by bonding to the electroactive species in its reduced state. The target gas can comprise carbon dioxide (CO₂), a sulfur oxide species such as sulfur dioxide (SO₂) or sulfur trioxide (SO₃), an organosulfate (R₂SO₄, where each R is independently hydrogen, C₁₋₁₂ alkyl, or C₆₋₂₀ aryl) such as dimethyl sulfate, a nitrogen oxide species such as nitrogen dioxide (NO₂) or nitrogen trioxide (NO₃), a phosphate ester (R₃PO₄, where each R is independently hydrogen, C₁₋₁₂ alkyl, or C₆₋₂₀ aryl) such as trimethyl phosphate, an ester (RCOOR′ where each R is independently hydrogen, C₁₋₁₂ alkyl, or C₆₋₂₀ aryl, and R′ is independently C₁₋₁₂ alkyl or C₆₋₂₀ aryl) such as methyl formate or methyl acrylate, an aldehyde (RCHO, where each R is independently hydrogen, C₁₋₁₂ alkyl, or C₆₋₂₀ aryl) such as formaldehyde or acrolein, a ketone (R₂CO, where each R is independently hydrogen, C₁₋₁₂ alkyl, or C₆₋₂₀ aryl) such as acetone, an isocyanate (RNCO, where each R is independently hydrogen, C₁₋₁₂ alkyl, or C₆₋₂₀ aryl, and each R′ is independently C₁₋₁₂ alkyl or C₆₋₂₀ aryl) such as methyl isocyanate, isothiocyanate (RNCS, where each R is independently hydrogen, C₁₋₁₂ alkyl, or C₆₋₂₀ aryl, and each R′ is independently C₁₋₁₂ alkyl or C₆₋₂₀ aryl), a borane (BR₃, where each R is independently hydrogen, C₁₋₁₂ alkyl, or C₆₋₂₀ aryl) such as trimethyl borane, or a borate (R₃BO₃, where each R is independently hydrogen, C₁₋₁₂ alkyl, or C₆₋₂₀ aryl) such as trimethyl borate. The target gas can optionally comprise a combination of any of the foregoing target gas species.

The patterned first electrode comprises a plurality of gas regions and a plurality of electrolyte regions (i.e., comprising an electrolyte). The electrolyte region includes an electrolyte and at least a portion of the conductive scaffold having the electroactive species disposed thereon, as discussed in further detail above. In an aspect, the electrolyte can include a liquid electrolyte, a gel electrolyte, a gel polymer electrolyte (GPE), a polymer ionic liquid (PIL), a room temperature ionic liquid (RTIL), an ionic liquid, a solution comprising a salt and an organic solvent, or any other suitable electrolyte or combination of electrolytes. Optionally, a crosslinker may be present in the electrolyte.

In an aspect, the electrolyte comprises a gel polymer electrolyte (GPE). A GPE comprises a polymer matrix with high affinity for the electrolyte, which is disposed in the polymer matrix. The electrolytic moiety is not covalently attached to the polymer matrix. The matrix polymer of the GPE can comprise, but is not limited to, poly(acrylate), poly(acrylamide), poly(styrene), poly(ethylene oxide), poly(vinylidine fluoride), poly(urethane), poly(siloxane), poly(vinylpyrrolidone), functionalized cellulose, or a combination thereof. Optionally, the polymer may contain functional groups that can form crosslinks such as ionic bonds, covalent bonds, or a combination thereof. Crosslinking can be triggered by heat, radiation, or a chemical trigger suitable for forming a crosslinked network that is co-localized with the electrolyte.

In an aspect, the electrolyte comprises a polymer ionic liquid (PIL). A PIL comprises an ionic polymer matrix, wherein the cation, the anion, or both the cation and the anion are covalently linked to the polymer backbone. When both the cation and the anion are covalently linked to the polymer backbone, the polymer ion liquid can be referred to as zwitterionic. The polymer backbone of the PIL can comprise, but is not limited to, poly(acrylate), poly(acrylamide), poly(styrene), poly(siloxane), poly(ethylene), poly(vinylidine fluoride), poly(ethylene oxide), poly(vinylpyrrolidone), poly(N-alkylimidazolium), poly(diallyldialkylammonium), or a combination thereof. Optionally, the polymer matrix may contain functional groups that can form crosslinks such as ionic bonds, covalent bonds, or a combination thereof. Crosslinking can be triggered by heat, radiation, or a chemical trigger suitable for forming a crosslinked network that is co-localized with the electrolyte. The repeat unit bearing the crosslinkable functional group may represent 5 to 95 mol % of the composition of the polymer. Exemplary polymer ionic liquids are further described in the working examples below.

In some aspects, a crosslinker can be added to the electrolyte. The crosslinker can comprise a small molecule, an oligomer, or a polymer containing functional groups that can participate in chemical reactions with complementary functional groups of repeat units of the GPE, the PIL, or both. Examples of the functional groups can include, but are not limited to, vinyl, azido, epoxy, hydroxy, carboxy, amino, isocyanato, aluminum salts, or any combination thereof. The crosslinking reaction of the functional group may be triggered by heat, radiation or any suitable chemical trigger, as discussed above.

In an aspect the electrolyte comprises an ionic liquid, for example a room temperature ionic liquid (RTIL). Ionic liquids, also referred to as molten salts because they are liquid at room temperature, e.g., 23° C., can have low volatility, for example a vapor pressure of less than 10⁻⁵ Pascal (Pa), or 10⁻¹⁰ to 10⁻⁵ Pa at a temperature of 23° C., which can reduce the risk of the separator drying out, and allow for reduction in loss of the electrolyte due to evaporation or entrainment. In an aspect the ionic liquid accounts for substantially all (e.g., at least 80 volume percent (vol %), or at least 90 vol %, or at least 95 vol %, or at least 98 vol %, at least 99 vol %, or at least 99.9 to 99.99 vol %) of the electrolyte.

The ionic liquid includes an anion component and a cation component. The anion of the ionic liquid can include, but is not limited to, one or more of halide, sulfate, sulfonate, carbonate, bicarbonate, phosphate, nitrate, nitrate, acetate, PF6, BF4, trifluoromethanesulfonate (triflate), nonaflate, bis(trifluoromethylsulfonyl)amide, trifluoroacetate, heptafluororobutanoate, haloaluminate, triazolide, or an amino acid derivative (e.g., proline with the proton on the nitrogen removed). The cation of the ionic liquid can include, but is not limited to, one or more of imidazolium, pyridinium, pyrrolidinium, phosphonium, ammonium, sulfonium, thiazolium, pyrazolium, piperidinium, triazolium, pyrazolium, oxazolium, guanidinium, an alkali cation, or dialkylmorpholinium. In an aspect, the room temperature ionic liquid includes an imidazolium as a cation component. In an aspect, the room temperature ionic liquid includes 1-butyl-3-methylimidazolium (“BMIM”) as a cation component. In an aspect, the room temperature ionic liquid includes bis(trifluoromethyl-sulfonyl)imide (“TFSI”) as an anion component. In an aspect, the room temperature ionic liquid includes 1-butyl-3-methylimidazolium bis(trifluoromethylsulfonyl)-imide (“[BMIM][TFSI]”). In an aspect, the room temperature ionic liquid includes 1-butyl-3-methylimidazolium tetrafluoroborate (“BF₄”) (“[BMIM][BF₄]”).

In an aspect, the electrolyte includes an ionic liquid that may include an unsubstituted or substituted imidazolium, an unsubstituted or substituted morpholinium, unsubstituted or substituted pyridinium, an unsubstituted or substituted pyrrolidinium, an unsubstituted or substituted piperidinium, an unsubstituted or substituted piperazinium, an unsubstituted or substituted pyrazinium, or a combination thereof. In a particular aspect, the ionic liquid may be 1-ethyl-3-methylimidazolium bis(trifluoromethanesulfonyl)imide, 1-ethyl-3-methylimidazolium bis(fluorosulfonyl)imide, 1-ethyl-3-methylimidazolium bis(pentafluorosulfonyl)imide, 1-ethyl-3-methylimidazolium dicyanamide, 1-ethyl-3-methylimidazolium tetrafluoroborate, 1-butyl-3-methylimidazolium bis(trifluoromethylsulfonyl)imide, 1-butyl-3-methylpyridinium bis(trifluoromethyl-sulfonyl)imide, N-methyl-N-propylpiperidinium bis(trifluoromethanesulfonyl)imide, or a combination thereof.

In an aspect, the ionic liquid electrolyte can be maintained in free form in the electrolyte region, for example by capillary action or wetting of the conductive scaffold with the ionic liquid. In an aspect, the ionic liquid electrolyte can be maintained in the electrolyte region by a crosslinked ionogel polymer matrix. In an aspect, electrolyte infiltration in the gas regions of the electrode is avoided, and in an aspect there is essentially no electrolyte infiltration in the gas regions of the electrode. Portions without electrolyte infiltration can remain empty and serve as gas channels.

In an aspect, the electrolyte region can include 15 to 85 vol % of the electrolyte, based on the total volume of the electrolyte region. Within this range, the electrolyte can be present in the electrolyte region in an amount of at least 15 vol %, at least 20 vol %, at least 25 vol %, at least 30 vol %, at least 35 vol %, at least 40 vol %, at least 45 vol %, at least 50 vol %, at least 55 vol %, at least 60 vol %, at least 65 vol %, at least 70 vol %, at least 75 vol %, or at least 80 vol %, each based on the total volume of the electrolyte region. Also within this range, the electrolyte can be present in the electrolyte region in an amount of no more than 85 vol %, no more than 80 vol %, no more than 75 vol %, no more than 70 vol %, no more than 65 vol %, no more than 60 vol %, no more than 55 vol %, no more than 50 vol %, no more than 45 vol %, no more than 40 vol %, no more than 35 vol %, no more than 30 vol %, no more than 25 vol %, or no more than 20 vol %, each based on the total volume of the electrolyte region. Combinations of the above-referenced values for the electrolyte volume percentage in the electrolyte region are also possible.

In an aspect, the electrolyte region can include a volume fraction of the conductive scaffold having the electroactive species disposed thereon sufficient to provide percolating pathways for electron transport within the electrodes. In an aspect, the electrolyte region can include 5 to 85 vol % of the conductive scaffold, based on the total volume of the electrolyte region. Within this range, the total volume of the conductive scaffold can be at least 5 vol %, at least 10 vol %, at least 15 vol %, at least 20 vol %, at least 25 vol %, at least 30 vol %, at least 35 vol %, at least 40 vol %, at least 45 vol %, at least 50 vol %, at least 55 vol %, or at least 60 vol %, based on a total volume of the electrolyte region. Also within this range, the electrolyte region can include no more than 65 vol %, no more than 60 vol %, no more than 55 vol %, no more than 50 vol %, no more than 45 vol %, no more than 40 vol %, no more than 35 vol %, no more than 30 vol %, no more than 25 vol %, no more than 20 vol %, no more than 15 vol %, or no more than 10 vol % of the conductive scaffold having the electroactive species disposed thereon, based on the total volume of the electrolyte region. Combinations of the above-referenced values for the volume percentage of the conductive scaffold having the electroactive species disposed thereon in the electrolyte region are also possible.

In an aspect, the electrolyte region can include a volume fraction of gas. For example, small or ionophobic pores may not completely fill with electrolyte during the assembly process and instead will contain a gas, e.g., air or an inert gas such as nitrogen. The electrolyte region can include 0 to 15 vol % of the gas, based on the total volume of the electrolyte region. Within this range, the electrolyte region can include at least 0 vol %, at least 0.1 vol %, at least 1 vol %, at least 5 vol %, at least 6 vol %, at least 7 vol %, at least 8 vol %, at least 9 vol %, at least 10 vol %, or at least 15 vol % of the gas, based on the total volume of the electrolyte region. Also within this range, the electrolyte region can include no more than 15 vol %, no more than 10 vol %, 5 vol %, no more than 1 vol %, no more than 0.5 vol %, no more than 0.2 vol %, or no more than 0.1 vol % of the gas, based on the total volume of the electrolyte region. Combinations of the above-referenced ranges for the gas volume percentage in the electrolyte region are also possible.

In an aspect, the electrolyte region can have a volume that is at least 50% of the total volume of the patterned electrode. For example, the electrolyte region can have a volume that is at least 55%, at least 60%, at least 65%, at least 70%, at least 75%, at least 80%, at least 85%, at least 90%, at least 95%, or at least 99% of the total volume of the patterned electrode. The electrolyte region can have a volume that is no more than 99%, no more than 95%, no more than 90%, no more than 85%, no more than 80%, no more than 75%, no more than 70%, no more than 65%, no more than 60%, or no more than 50% of the total volume of the patterned electrode. Combinations of the above-referenced values for the volume percentage of the electrolyte region compared to the total volume of the patterned electrode are also possible.

The patterned first electrode further includes a gas region. Inclusion of the gas region in the cell can reduce the adsorption time constant of the cell. A reduction in the adsorption time constant can increase the amount of gas the cell can adsorb per unit area per time. In an aspect, the gas region can include one or more gases. In an aspect, the gas can comprise O₂, N₂, CO₂, SO₂, NO, NO₂, H₂S, CO, H₂O, or a combination thereof. In an aspect, the gas region can be filled with inert gas on initial application of the first (e.g., cathodic) potential.

In an aspect, the gas region can include the electrically conductive scaffold material and an electroactive species. In an aspect, the gas region can include the electrolyte. For example, the gas region can include the electrolyte in an amount of 0 to 20 vol %, based on the total volume of the gas region. Within this range, the gas region can include the electrolyte in an amount of at least 0 vol %, at least 0.1 vol %, at least 0.2 vol %, at least 0.3 vol %, at least 0.4 vol %, at least 0.5 vol %, at least 0.6 vol %, at least 0.7 vol %, at least 0.8 vol %, at least 0.9 vol %, at least 1 vol %, at least 2 vol %, at least 3 vol %, at least 4 vol %, at least 5 vol %, at least 6 vol %, at least 7 vol %, at least 8 vol %, at least 9 vol %, at least 10 vol %, at least 11 vol %, at least 12 vol %, at least 13 vol %, at least 14 vol %, at least 15 vol %, at least 16 vol %, at least 17 vol %, at least 18 vol %, or at least 19 vol %, each based on the total volume of the gas region. Also within this range, the gas region can include the electrolyte in an amount of no more than 20 vol %, no more than 19 vol %, no more than 18 vol %, no more than 17 vol %, no more than 16 vol %, no more than 15 vol %, no more than 14 vol %, no more than 13 vol %, no more than 12 vol %, no more than 11 vol %, no more than 10 vol %, no more than 9 vol %, no more than 8 vol %, no more than 7 vol %, no more than 6 vol %, no more than 5 vol %, no more than 4 vol %, no more than 3 vol %, no more than 2 vol %, no more than 1 vol %, no more than 0.9 vol %, no more than 0.8 vol %, no more than 0.7 vol %, no more than 0.6 vol %, no more than 0.5 vol %, no more than 0.4 vol %, no more than 0.3 vol %, no more than 0.2 vol %, or no more than 0.1 vol %, each based on the total volume of the gas region. Combinations of the above-referenced ranges for the electrolyte volume in the gas region are also possible.

In an aspect, the gas region can have any suitable shape, and can have a spherical shape, a cylindrical shape, a striped shape, a conical shape, a conical frustrum shape, an irregular shape, or any combinations thereof. In an aspect, the gas region can run the entire length of the patterned electrode and can physically contact both a gas flowfield and a separator, when present, as further discussed below.

The gas region can comprise a plurality of gas regions. When present, the plurality of gas regions each can have an average dimension in the y direction (e.g., a thickness) (W_{G}) of 1 to 100 μm. Within this range, the gas regions can each have an average dimension in the y direction (W_{G}) of at least 1 μm, at least 2 μm, at least 3 μm, at least 4 μm, at least 5 μm, at least 6 μm, at least 7 μm, at least 8 μm, at least 9 μm, at least 10 μm, at least 20 μm, at least 30 μm, at least 40 μm, at least 50 μm, at least 60 μm, at least 70 μm, at least 80 μm, or at least 90 μm. Also within this range, the gas regions can each have an average dimension in the y direction (W_{G}) of no more than 100 μm, no more than 90 μm, no more than 80 μm, no more than 70 μm, no more than 60 μm, no more than 50 μm, no more than 40 μm, no more than 30 μm, no more than 20 μm, no more than 10 μm, no more than 9 μm, no more than 8 μm, no more than 7 μm, no more than 6 μm, no more than 5 μm, no more than 4 μm, no more than 3 μm, or no more than 2 μm. Combinations of the above-referenced average diameter values for the gas regions are also possible.

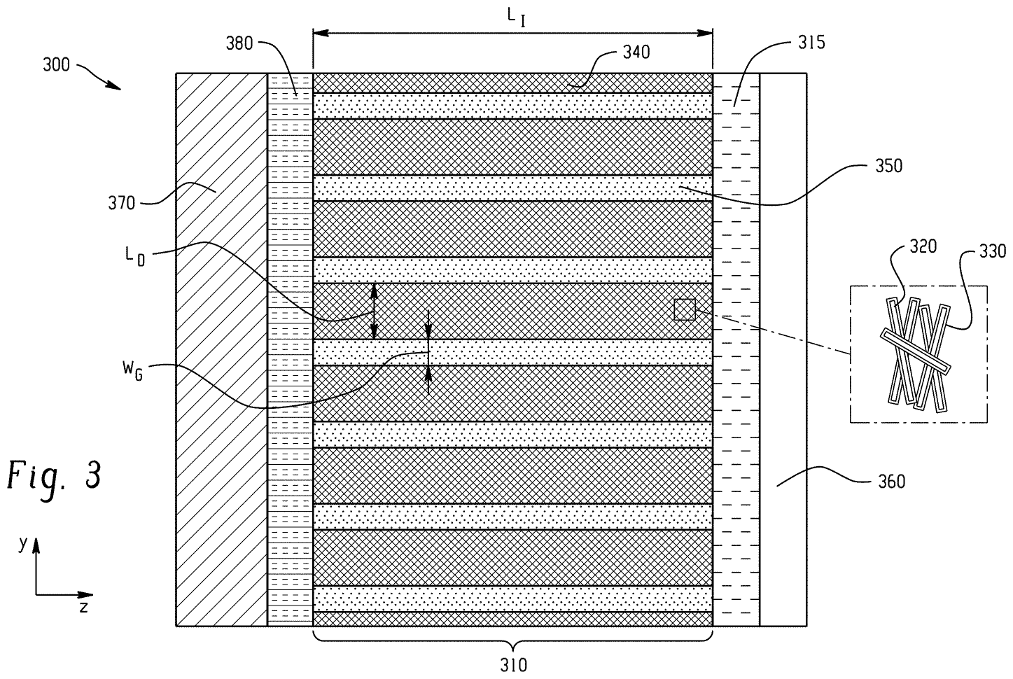

In an aspect, the gas regions of the plurality of gas regions can be separated by an average distance. The average distance between the gas regions can determine the diffusion length L_{D} of a path the Lewis acid gas G follows to diffuse from a gas region to an active site of the electroactive species P within the electrolyte region, for example, as depicted in FIG. 3. In other words, the gas regions can be interspersed within portions of the electrolyte region. A gas region can be separated from a neighboring gas region by an average distance of 1 μm to 1 mm. Within this range, a gas region can be separated from a neighboring gas region by an average distance of at least 1 μm, at least 2 μm, at least 3 μm, at least 4 μm, at least 5 μm, at least 6 μm, at least 7 μm, at least 8 μm, at least 9 μm, at least 10 μm, at least 20 μm, at least 30 μm, at least 40 μm, at least 50 μm, at least 60 μm, at least 70 μm, at least 80 μm, at least 90 μm, at least 100 μm, at least 200 μm, at least 300 μm, at least 400 μm, at least 500 μm, at least 600 μm, at least 700 μm, at least 800 μm, or at least 900 μm. Also within this range, a gas region can be separated from a neighboring gas region by an average distance of no more than 1 mm, no more than 900 μm, no more than 800 μm, no more than 700 μm, no more than 600 μm, no more than 500 μm, no more than 400 μm, no more than 300 μm, no more than 200 μm, no more than 100 μm, no more than 90 μm, no more than 80 μm, no more than 70 μm, no more than 60 μm, no more than 50 μm, no more than 40 μm, no more than 30 μm, no more than 20 μm, no more than 10 μm, no more than 9 μm, no more than 8 μm, no more than 7 μm, no more than 6 μm, no more than 5 μm, no more than 4 μm, no more than 3 μm, or no more than 2 μm. Combinations of the above-referenced ranges for the average distance between the gas regions are also possible.

In an aspect, the gas region can have a volume that is at least 0.1% of the total volume of the patterned electrode. For example, the gas region can have a volume that is at least 0.5%, at least 1%, at least 2%, at least 3%, at least 4%, at least 5%, at least 10%, at least 15%, at least 20%, at least 25%, at least 30%, at least 35%, at least 40%, or at least 50% of the total volume of the patterned electrode. In an aspect, the gas region can have a volume that is no more than 50%, no more than 45%, no more than 40%, no more than 35%, no more than 30%, no more than 25%, no more than 20%, no more than 15%, no more than 10%, no more than 5%, no more than 4%, no more than 3%, no more than 2%, no more than 1%, no more than 0.5%, or no more than 0.2% of the total volume of the patterned electrode. Combinations of the above-referenced values for the volume percentage of the gas region compared to the total volume of the patterned electrode are also possible.

In an aspect, the gas region can optionally be filled with porous materials which are non-wetting towards the electrolyte. When present, the porous materials in the gas region can include a zeolite. As used herein, the term “zeolite” refers to crystalline aluminosilicates of group IA and group IIA elements such as sodium, potassium, magnesium, calcium, or a combination thereof. The zeolites can have an extending framework of AlO₄ and SiO₄ tetrahedra linked to each other by the sharing of oxygen ions. The framework generally includes channels or interconnected voids which can provide a host structure permeated by micropores which, in some aspects, can amount to up to 50% of the zeolite by volume. The zeolite can be a natural or synthetic zeolite. Natural zeolites are hydrous silicates of aluminum, optionally comprising sodium or calcium, and having ion exchange properties, large surface areas and a homogenous and finite porosity. Natural zeolites can include, for example, analcime, chabazite, clinoptilolite, erionite, faujasite, harmotome, heulandite, mordenite, natrolite, philipsite, scolecite, and stilbite. Synthetic zeolites are commercially available from a number of manufacturers including Tosoh America, Inc. or CB Minerals and can include, for example, zeolite A, zeolite X, zeolite Y, and zeolite L. Synthetic zeolites are highly porous materials and in contrast to other adsorbents have pores which are of molecular dimensions and uniform size. The zeolite can have an average particle size of, for example, 1 to 100 micrometers, preferably 2 to 50 micrometers, more preferably 10 to 20 micrometers. When included in the electrode, the zeolite particles can be present in an amount of 1 to 70 weight percent, or 10 to 60 weight percent, or 10 to 50 weight percent, or 20 to 60 weight percent, or 20 to 50 weight percent, each based on the total weight of the first electrode.

The patterned first electrode can have a thickness that effectively determines the distance L_{I} a cation migrates from the separator to the active site of the electroactive species P in an ESA cell. In an aspect, the thickness of the first electrode can be 15 to 500 micrometers. Within this range, the patterned first electrode can have a thickness of at least 15 μm, at least 25 μm, at least 50 μm, at least 100 μm, at least 150 μm, at least 200 μm, at least 250 μm, at least 300 μm, at least 350 μm, at least 400 μm, or at least 450 μm. Also within this range, in an aspect, the patterned electrode can have a thickness of no more than 450 μm, no more than 400 μm, no more than 350 μm, no more than 300 μm, no more than 250 μm, no more than 200 μm, no more than 150 μm, no more than 100 μm, no more than 50 μm, no more than 40 μm, or no more than 30 μm. Combinations of the above-referenced thicknesses for the patterned first electrode are also contemplated.

In an aspect, L_{D}/L_{I} can be 0.001 to 1 (i.e., 0.001/1 to 1/1). Within this range, L_{D}/L_{I} can be at least 0.001, at least 0.002, at least 0.003, at least 0.004, at least 0.005, at least 0.006, at least 0.007, at least 0.008, at least 0.009, at least 0.01, at least 0.02, at least 0.03, at least 0.04, at least 0.05, at least 0.06, at least 0.07, at least 0.08, at least 0.09, at least 0.1, at least 0.2, at least 0.3, at least 0.4, at least 0.5, at least 0.6, at least 0.7, at least 0.8, or at least 0.9. Also within this range, L_{D}/L_{I} can be no more than 1, no more than 0.9, no more than 0.8, no more than 0.7, no more than 0.6, no more than 0.5, no more than 0.4, no more than 0.3, no more than 0.2, no more than 0.1, no more than 0.09, no more than 0.08, no more than 0.07, no more than 0.06, no more than 0.05, no more than 0.04, no more than 0.03, no more than 0.02, no more than 0.01, no more than 0.009, no more than 0.008, no more than 0.007, no more than 0.006, no more than 0.005, no more than 0.004, no more than 0.003, or no more than 0.002. Combinations of the above-referenced L_{D}/L_{I} values are also possible.

In an aspect, L_{D}/W_{G} can be 1 to 100 (i.e., 1/1 to 100/1). Within this range, L_{D}/W_{G} can be at least 1, at least 2, at least 3, at least 4, at least 5, at least 6, at least 7, at least 8, at least 9, at least 10, at least 20, at least 30, at least 40, at least 50, at least 60, at least 70, at least 80, or at least 90. Also within this range, L_{D}/W_{G} can be no more than 100, no more than 90, no more than 80, no more than 70, no more than 60, no more than 50, no more than 40, no more than 30, no more than 20, no more than 10, no more than 9, no more than 8, no more than 7, no more than 6, no more than 5, no more than 4, no more than 3, or no more than 2. Combinations of the above-referenced L_{D}/W_{G} values are also possible.

In an aspect, the electroswing adsorption cell can further comprise a second electrode. The second electrode comprises a complementary electroactive composite layer. The complementary electroactive composite layer can be the same or different in composition or structure from the patterned first electrode of the present disclosure. The complementary electroactive composite layer comprises a second electroactive species which can be the same or different as the electroactive species of the patterned first electrode.

In an aspect, the complementary electroactive composite layer comprises the same electroactive species as the patterned first electrode. It will be understood that when the composite of the patterned first electrode and the complementary electroactive composite layer comprise the same electroactive species, the electroactive species of the patterned first electrode may be in a different oxidation state than the electroactive species of the complementary electrode during a charging process. In an aspect, the complementary electroactive composite layer comprises a second electroactive species which is different from the first electroactive species of the patterned first electrode. In an aspect the second electroactive species of the complementary electroactive composite layer can be an electroactive organic molecule, an electroactive polymer, or an electroactive oligomer, as previously described, or an electroactive inorganic complex, an electroactive metallocene, or a combination comprising any of the foregoing.

In an aspect, the complementary electroactive species can be an electroactive inorganic complex, for example an alkali metal-transition metal oxide or an alkali metal-transition metal phosphate of the formula

AM¹X

wherein A is L_{I}, Na, or K; M¹ is Ni, Co, Mn, Al, Ti, Mo, Fe, V, Si, or a combination thereof; and X is O₂ or PO₄. In an aspect, the electroactive species can be LiFePO₄.

In an aspect, the complementary electroactive species comprises a metallocene. An example of a suitable metallocene can include, but is not limited to, ferrocene, or a polymer comprising repeating units derived from ferrocene (e.g., polyvinyl ferrocene), or derivatives thereof.

In an aspect, the second electroactive species of the complementary electroactive composite layer comprises a MXene. MXene, as used herein, refers to materials comprising metal carbides, anitrides, carbonitrides, or a combination thereof.

During operation of the electroswing adsorption cell, the second electroactive species of the complementary electroactive composite layer can serve as a source of electrons for the reduction of the first electroactive active species of the patterned first electrode. Likewise, the second electroactive species of the complementary electroactive composite layer can serve as a sink for electrons during the oxidation of the first electroactive species of the patterned first electrode.

In an aspect, the second electrode can further comprise a substrate, which can be positioned proximate to or between complementary electroactive composite layers. The substrate can be in direct or indirect contact with the complementary electroactive composite layer or layers. When present, the substrate can include, for example, carbon paper (treated, PTFE-treated, or untreated), carbon cloth, nonwoven carbon mat, or a nonwoven carbon nanotube mat. In an aspect, the support can be the same as the conductive scaffold of the patterned first electrode. In an aspect, the substrate of the second electrode can be a conductive material and can act as a current collector within the electroswing adsorption cell.

In an aspect, the patterned first electrode can be a negative electrode, and the second electrode can be a positive electrode. The terms anode or negative electrode and cathode or positive electrode are used for convenience and clarity, although they may be technically accurate only when the target gas is being acquired or released.

In an aspect, the second electrode can be positioned between patterned first electrodes. Each of the patterned first electrodes can be as described previously. In an aspect the patterned first electrodes and/or second electrodes can be identical in configuration or composition.

In an aspect, the second electrode can have a thickness of 25 to 500 micrometers. In an aspect, within this range, the second electrode can have a thickness of at least 30 μm, at least 40 μm, at least 50 μm, at least 100 μm, at least 150 μm, at least 200 μm, at least 250 μm, at least 300 μm, at least 350 μm, at least 400 μm, or at least 450 μm. Also within this range, the second electrode can have a thickness of no more than 450 μm, no more than 400 μm, no more than 350 μm, no more than 300 μm, no more than 250 μm, no more than 200 μm, no more than 150 μm, no more than 100 μm, no more than 50 μm, no more than 40 μm, or no more than 30 μm. Combinations of the above-referenced thicknesses for the second electrode are also contemplated.

The electroswing adsorption cell can further comprise a separator positioned between the patterned first electrode and the second electrode. The separator can serve as a protective layer that can prevent the respective electrochemical reactions at each electrode from interfering with each other. The separator can also help electronically isolate the first and second electrodes from one another or from other components within the electroswing adsorption cell to prevent a short-circuit. A person of ordinary skill, with the benefit of this disclosure, would be able to select a suitable separator.

In an aspect, the electroswing adsorption cell comprises a single separator, disposed between the patterned first electrode and the second electrode, e.g., between the negative electrode and the positive electrode. Electroswing adsorption cells can be combined to make a stack in any suitable combination of parallel and series configurations. Thus, in an aspect, the electroswing adsorption cell can comprise more than one separator. For example, one of skill in the art would understand that depending on the selected combination of series and parallel configurations, a single separator may be used, or a plurality of separators may be preferred.

The separator can be a porous separator. The porous separator can comprise any suitable material. In an aspect, the porous separator can comprise a polymer film, for example a film comprising a polyamide, a polyolefin, a polyaramid, a polyester, a polyurethane, an acrylic resin, or a combination thereof. The polymer may be coated on one or both sides with a ceramic nanoparticle. In an aspect, the porous separator can comprise cellulose, a synthetic polymeric material, or a polymer/ceramic composite material. Further examples of separators can include polyvinylidene difluoride (PVDF) separators, polytetrafluoroethylene (PTFE), PVDF-alumina composite separators, or a microporous olefin, such as a microporous polyethylene or microporous polypropylene.

In an aspect, the patterned first electrode can be folded or pleated into a desired configuration. In an aspect, the patterned first electrode, the separator, and the second electrode can be folded or pleated together into a desired configuration. Pleated or folded configurations will be discussed further below.

The electroswing adsorption cell can further comprise a current collector which conducts electrons from the electrode to the adjacent cell (in series-stacked configurations) or from the electrode to a terminal connection (in parallel-stacked configurations). The current collector can comprise, for example, carbon, a metal, or a combination thereof. In an aspect, the current collector can comprise carbon. Suitable examples of the carbon can include, but are not limited to, graphite, flaked graphite, expanded graphite, carbon fiber, carbon nanotubes, amorphous carbon, graphene, or a combination thereof. The carbon nanotubes may comprise single-wall carbon nanotubes or multi-wall carbon nanotubes. Carbon nanotubes are primarily carbon, although the nanotube fiber may further comprise other atoms, such as boron, nitrogen, or one or more of various metals. In an aspect, the current collector can comprise a metal. The metal can comprise Fe, Zn, Ti, Cu, Al, Ni, Mg, Sn, Cr, Mn, Au, Mo, W, In, V, Nb, Ag, an alloy or intermetallic thereof, or a combination thereof. In an aspect the alloy is a stainless steel, such as 304 or 316 stainless steel.

In an aspect, the carbon or metal may have a spherical, flake, or fibrous morphology. In an aspect, the metal may be in the form of a metal mesh, foam, felt, or an expanded metal. The carbon or metal particles can be oriented. For example, when the metal is in the form of a fiber, the fibers can be oriented such that a long axis is oriented in a direction perpendicular to a major surface of the current collector, e.g., such that the fiber is oriented orthogonal to the surface, e.g., in a through-plane direction.

In an aspect, the current collector can comprise a composite comprising the carbon, the metal, and a binder. The carbon or metal in the composite can be present in an amount of 10 to 98 vol %, based on the total volume of the composite. In an aspect, the composite comprises the carbon or the metal in an amount of 50 to 95 vol %, based on the total volume of the composite. In an aspect, the composite comprises carbon nanotubes or graphene and can include the carbon nanotubes or graphene in an amount of 10 to 40 vol %, based on the total volume of the composite. The composite may comprise a pore, and the pore may contain a polymer.

The binder, when present, can comprise a polymer. The binder can be a thermoset or a thermoplastic. Suitable polymer binders can include, for example, an epoxy, a phenolic, a vinyl ester, a polyarylene sulfide, a polybenzoxazine, an isocyanate, a fluoropolymer, a rubber, or a combination thereof. Representative polymer binders can include polyacrylic acid (PAA), polyvinylidene difluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, or a fluorinated rubber. A combination comprising one of the foregoing polymer binders may be used.

The binder can optionally further include an additive. Specific additives can include flow promoters, mold release agents, or a combination thereof. In an aspect, the polymer binder can be crosslinked. The polymer can be an electrical insulator or an electrical conductor. An exemplary electrically conducting polymer can be found, for example, in U.S. Publication No. 2004/977797, the contents of which are incorporated by reference herein in their entirety for all purposes. Optionally, a conductive material such as carbon black, nanotubes, carbon fiber, graphene, and the like can be embedded in the polymer binder at a surface of the current collector, which, without wishing to be bound by theory, is believed to reduce the contact resistance to an adjacent cell component such as to the gas diffusion layer.

In an aspect, the current collector can optionally comprise a coating disposed on at least a portion of a surface of the current collector. The coating can, without wishing to be bound by theory, serve to reduce corrosion, block ion or gas permeation, or improve electrical contact to the gas-diffusion layer or electrode. The coating, when present, can comprise carbon, a metal, an alloy, or an intermetallic material, or a combination thereof, wherein the metal, alloy, or intermetallic material comprises Ni, Zn, Ti, Sn, Au, V, Mo, Cr, or a combination thereof. The coating can comprise an oxide, boride, nitride, or carbide of a metal, alloy, or intermetallic. Non-limiting examples of coating compositions can include tin oxide, titanium carbide, tungsten carbide, zirconium carbide, indium tin oxide, indium zinc oxide, titanium boride, zirconium boride, titanium niobium oxide, titanium tantalum oxide, lanthanum strontium chromium oxide, lanthanum strontium cobalt oxide, titanium nitride, chromium nitride, vanadium nitride, or a combination thereof. For example, in an aspect, the current collector can be plated with a metal, such as Fe, Ni, or Au, or a corrosion-resistant material such as TiN. In an aspect, the coating can comprise a polymer. An example of a polymer coating is described, for example, in U.S. Publication No. 2007/0298267, the contents of which are incorporated by reference herein in their entirety for all purposes. In an aspect, the coating can comprise an electrically conducting polymer. In an aspect, the coating can comprise the binder as described above, and particles of a conductive material, such as carbon black, carbon nanotubes, graphene, gold, silver, or a combination thereof. In an aspect, the coating comprises vapor-deposited diamond-like carbon, or a product of pyrolysis of a carbonaceous polymer.

The current collector may have any suitable porosity, and in an aspect is nonporous. In an aspect, the current collector is effectively impervious to a target gas, e.g., carbon dioxide.

The electroswing adsorption cell may be stacked in series, and the current collector may block transport of ions and of reactant and released gas from a first cell to a second neighboring cell. Furthermore, the current collector can impart mechanical structure and stability to an electroswing adsorption cell. The current collector can optionally comprise ribs which form channels which provide a flowfield for distribution of the gas across the cell. The rib may conduct electrons across the electroswing adsorption cell and optionally provide desirable structural integrity. The rib, when present, can comprise, for example, carbon, a metal, a composite, or a combination thereof, as disclosed above, and can optionally include the coating, each of which is further described above. The rib may comprise the same material as the current collector. The rib may comprise a different material from the current collector. The rib may comprise a material which can be partially compressed, in order to accommodate manufacturing thickness tolerances. For example, the rib may comprise an electronically-conductive closed-cell foam or gasket. The ribs may be convex or concave portions relative to the surface of the current collector and can have any suitable cross-sectional shape, for example a rectangular or rounded shape.

In an aspect, a first side of the current collector can face an adsorbent electrode (e.g., the patterned first electrode), and a second, opposite side of the current collector faces a non-adsorbent counter electrode (e.g., the second electrode) or an end plate. In an aspect, both sides of the current collector can face adsorbent electrodes. The side of the current collector which faces an adsorbent electrode may comprise a flow field. The sides of the current collector, e.g., the first side and the second side, can each independently comprise the same or a different material. In an aspect, an intervening layer comprising a barrier material, such as a material which is electrically conductive and can block the transport of ions or gas, can be interposed between the first and second sides of the current collector. In an aspect, the barrier material can comprise a metal foil.

The current collector can include a feature to aid with sealing the perimeter of the apparatus. Such features can include grooves, steps, bevels, or a combination thereof. Such features are described, for example, in U.S. Publication No. 2002/0197519, the contents of which are incorporated by reference herein in their entirety for all purposes.

The current collector can further comprise a channel extending through the interior of the current collector, preferably through which coolant can flow. The coolant channel can be arranged so that the coolant flow rate is highest in the region of the cell expected to have the highest rate of heat generation, as can be readily determined by one of ordinary skill in the art. Use of a parallel or serpentine configuration is mentioned. In an aspect in which a foam or mesh, such as an electrically conductive foam or mesh, is used, the coolant can flow through the foam or mesh. The foam or mesh may be provided between two layers of the current collector. In an aspect, the coolant can flow through a corrugated or waveform structure, provided between opposite layers of the current collector.

In an aspect, the current collector can comprise a first sheet that contains a channel for reactant gas flow on a first face, and a channel for coolant on a second, opposite face. The first sheet can be attached to a second sheet, which forms a boundary for the coolant channels while providing electrical conduction orthogonal to the face of the sheets. The first sheet can be attached to the second sheet by any suitable method, for example, brazing, welding, soldering, laminating, diffusion bonding, compression, or adhesive bonding. The coolant channels can be formed by nesting adjacent plates, which contain flow-fields for the first and second electrodes. Coolant channels are described in U.S. Pat. No. 6,099,984, and further exemplary coolant flow patterns can be found in provided in U.S. Publication Nos. 2004/0209150 and 2003/0203260, the contents of each of which are incorporated by reference herein in their entirety for all purposes.

The current collector can further comprise a sensor, e.g., a voltage sensor or a voltage sensing wire connected to the current collector. In an aspect, the current collector can further comprise a heating element.

In an aspect, the current collector can comprise members to facilitate assembly, such as alignment pins. Alternatively, a frame may be provided at a periphery of the current collector to aid alignment or sealing. Examples of various suitable current collector components can be found in U.S. Publication No. 2003/0022052, the contents of which are incorporated by reference herein in their entirety for all purposes.

The electroswing adsorption cell can optionally further comprise a gas flow field. The gas flow field, when present, can be positioned between the first electrode and the current collector. When the gas diffusion layer is not present in the electroswing adsorption cell, the gas flow field can be positioned adjacent to the first electrode, on a side opposite the separator. In an aspect, the gas flow field can be positioned adjacent to a current collector or a side of the current collector may comprise a flow field. The flow field can comprise structures for directing the reacting fluid to flow from a flow inlet to a flow outlet. Without wishing to be bound by theory, the flow field serves to provide uniform reactant flow to the electrode area. Preferably, the flow field provides uniform reactant flow to the electrode area, a low barrier to flow e.g., a low pressure drop, and suitable electrical conduction from the electrode through the flow field to the current collector.

The gas flow field can optionally further comprise a gas diffusion layer. The gas diffusion layer can be positioned adjacent to the first electrode, on a side opposite the separator. The gas diffusion layer can comprise a porous, electrically conductive material. In an aspect, the gas diffusion layer has a porosity, for example, of greater than or equal to 60%, greater than or equal to 70%, greater than or equal to the 75%, greater than or equal to 80%, or greater. In an aspect, the gas diffusion layer has a porosity of less than or equal to 85%, less than or equal to 90%, or more. Combinations of these ranges are possible. For example, in an aspect, the gas diffusion layer of the first electrode has a porosity of greater than or equal to 60% and less than or equal to 90%. Other porosities are also possible. Examples of suitable materials for the gas diffusion layer include, without limitation, carbon paper (treated, PTFE-treated, or untreated), carbon cloth, or a nonwoven carbon fiber or carbon nanotube mat.

In an aspect, the flow field can comprise a porous foam or mesh. The foam or mesh can be bonded to a nonporous plate by a conductive adhesive, welding, heat-bonding, or sintering.

The flow field can comprise a channel. The channel can be defined by two or more ribs. In an aspect, the channels, the ribs, or both can each independently have average widths of at least 0.1 mm, at least 0.2 mm, at least 0.3 mm, at least 0.4 mm, at least 0.5 mm, at least 0.6 mm, at least 0.8 mm, at least 0.9 mm, at least 1 mm, at least 2 mm, at least 3 mm, at least 4 mm, at least 5 mm, at least 6 mm, at least 7 mm, at least 8 mm, or at least 9 mm. In an aspect, the channels, the ribs, or both can each independently have average widths of no more than 10 mm, no more than 9 mm, no more than 8 mm, no more than 7 mm, no more than 6 mm, no more than 5 mm, no more than 4 mm, no more than 3 mm, no more than 2 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, or no more than 0.2 mm. Combinations of the above-referenced average widths for the channels and/or the ribs are also possible.

In an aspect, the channels, the ribs, or both can each independently have average depths of at least 0.1 mm, at least 0.2 mm, at least 0.3 mm, at least 0.4 mm, at least 0.5 mm, at least 0.6 mm, at least 0.8 mm, at least 0.9 mm, at least 1 mm, at least 2 mm, or at least 3 mm. In an aspect, the channels, the ribs, or both can each independently have average depths of no more than 4 mm, no more than 3 mm, no more than 2 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, or no more than 0.2 mm. Combinations of the above-referenced average depths for the channels and/or the ribs are also possible.

Various methods for manufacturing a flow field may be used, e.g., machining, injection molding, compression molding, extruding, embossing, or stamping. Exemplary methods are described, for example, in U.S. Publication No. 2004/0151975 and U.S. Publication No. 2003/0022052, the contents of each of which are incorporated by reference herein in their entirety for all purposes. In an aspect, the flow field can comprise a corrugated metal with couplings to route the flow from one channel to a neighboring channel, for example as described in U.S. Publication No. 2002/0081477, the contents of which are incorporated by reference herein in their entirety for all purposes.

A flow pattern of the flow field can have any suitable configuration, e.g., to provide parallel, serpentine, or interdigitated flow. Non-limiting examples of serpentine flow patterns are provided in U.S. Pat. No. 6,309,773, the contents of which are incorporated by reference herein in their entirety for all purposes. Flow channels can have a uniform cross-section or can have regions which are tapered or constricted, e.g., to provide a suitable distribution of reactant across the cell area. The flow channels may contain a disruption or obstacle, e.g., to generate turbulence which can improve transport of reactants into the electrode. Exemplary flow channels are described in U.S. Pat. No. 6,756,149, the contents of which are incorporated by reference herein in their entirety for all purposes. The flow field pattern and dimensions can be the same for each flow field in a cell, or they can vary depending on the position of the cell within the stack and the nature of the electrode facing the flow field, as can be readily determined by a skilled person. In an aspect, when channels on both faces of the current collector are present, the channels can be nested to reduce the thickness of the stack.

In an aspect, a manifold can be used to deliver a process gas, e.g., a reactant gas, to the electroswing adsorption cell, and to convey a product gas, e.g., a released gas, away from the electroswing adsorption cell. The manifold can distribute the gas. Parameters such as manifold length and cross-sectional dimensions can be selected to provide suitable properties, such as pressure drop. The manifold can also preferably prevent leakage of the gas. Exemplary manifold designs that can be used include but are not limited to those disclosed in U.S. Pat. Nos. 6,159,629; 6,174,616; 5,486,430; 5,776,625; and 6,017,648; the contents of each which are incorporated by reference herein in their entirety for all purposes.

In an aspect, the electroswing adsorption cell can include a seal to prevent leakage of process gases out of the electroswing adsorption cell. The surface facing the seal region, e.g., a surface of the gas-diffusion layers, electrodes, or separators, can be impregnated at their periphery with a gas-impermeable sealant. Preferably, the geometry of the seal is selected such that stress that can result in puncture, fatigue, or tearing of the separator is not introduced. The thickness of the seal can be uniform or can vary across different regions of the seal with respect to the edge of the electrode and the gas diffusion layer. The seal is electrically insulating and chemically and electrochemically unreactive. The seal can comprise a suitable o-ring, gasket, or adhesive. The seal can comprise a ridge or bead of fluid-impermeable material deposited on the periphery of a member, such as the current collector or manifold. In an aspect, the seal can comprise an elastomer, and can be a thermoset or a thermoplastic, for example, an epoxy, a rubber, a polyolefin, a silicone, a fluoropolymer, a fluoro-elastomer, or a chloropolymer. In an aspect, the seal can comprise a foam, for example a foamed rubber. In an aspect, the seal can comprise a heat-shrinkable film. Exemplary seal materials are described in U.S. Pat. No. 6,440,597 and U.S. Publication No. 2006/0073385, the contents of each of which are incorporated by reference herein in their entirety for all purposes.

In an aspect, when the seal is a gasket, the gasket can optionally comprise a filler, which preferably can provide a coefficient of thermal expansion of the gasket material that is matched to that of the adjacent material, e.g., the current collector material. Exemplary fillers can include, but are not limited to, glass, polystyrene, poly(tetrafluoroethylene) (PTFE), or an insulating metal oxide such as silica or alumina.

Suitable seals can be manufactured by any suitable method, e.g., injecting a bonding polymer into a groove around the edge of the cell, for example as described in U.S. Publication No. 2003/0031914, the contents of which are incorporated by reference herein in their entirety for all purposes. The method can comprise forming grooved surfaces with correspondingly shaped gaskets, for example as described in U.S. Publication No. 2003/0072988, the contents of which are incorporated by reference herein in their entirety for all purposes. In an aspect, the sealant material can be coated, sprayed, laminated, or injection molded onto the current collector or onto an assembly of the gas diffusion layer, electrodes, separator, or a combination thereof. The sealant can encapsulate the exterior-facing edges of the cell. Examples of seal geometries are described in U.S. Publication Nos. 2007/0231619, 2007/0042254, and 2002/0172852, and U.S. Pat. No. 6,261,711, the contents of each of which are incorporated by reference herein in their entirety for all purposes. In an aspect, a gasket on opposite sides of the separator can be connected to each other through through-holes optionally included in a peripheral region of the separator.

To improve sealing, in an aspect the separator can be nonporous in the periphery region. A method of rendering the separator nonporous comprises hot-pressing the separator at a temperature sufficient to cause the material (e.g., a polymeric material) of the separator to flow, thereby filling the pores. The separator can be hot-pressed or thermally bonded to a gasket, or adhered with a sealant.

It can be advantageous to remove heat from the electroswing adsorption cell to prevent the internal temperature from exceeding temperatures that can damage the electroswing adsorption cell. Heat removal can be achieved through the use of coolant channels, discussed previously. In an aspect, the electroswing adsorption cell can be cooled by blowing air over a side of the electroswing adsorption cell. In an aspect, the electroswing adsorption cell can be cooled by flowing coolant through tubes or ducts alongside a side or within the electroswing adsorption cell. In an aspect, the current collector can be devoid of any coolant channels, and cooling can be provided by controlling the flow rate of a process gas through the electroswing adsorption cell, effectively using the process gas as a coolant. This cooling method can be particularly advantageous if the process gas (reactant gas) is air.

In an aspect, at least a portion of the electroswing adsorption cell can be heated. For example, an end portion of the electroswing adsorption cell can be heated, or the cells at the ends of the electroswing adsorption cell (e.g., the “end cells”) can be heated. Without wishing to be bound by theory, heating the electroswing adsorption cell can enable higher capture rate or prevent water condensation from a humid process gas. Electrical-resistance heating elements can be incorporated or disposed adjacent to an end plate or a manifold, for example.

Applying pressure across an electroswing adsorption cell can be advantageous to reduce contact resistance between components within the electroswing adsorption cell e.g., contact resistance between the flow field and the gas diffusion layer. Application of pressure can also be advantageous to improve seal hermeticity. Pressure can be applied across an electroswing adsorption cell, for example, using tie rods or external clamps. A tie rod can be internal or external to the seals and manifolds. It can be preferable to apply pressure uniformly, without localized regions of mechanical stress that can lead to mechanical failure. Those skilled in the art will be familiar with the design of washers, disc springs, coiled springs, belleville washers, nuts, clamps, frames, fasteners, collets, wedges, or pressure plates to apply uniform pressure and avoid stress concentration. Examples of compression assemblies are described in, for example, U.S. Pat. No. 6,190,793, the contents of which are incorporated by reference herein in their entirety for all purposes.

In an aspect, the electroswing adsorption cell can advantageously, at room temperature and at ambient pressure and concentration, capture Lewis acids (e.g., CO₂) at a rate of at least 1 g of Lewis acid/m²/hr, at least 2 g of Lewis acid/m²/hr, at least 3 g of Lewis acid/m²/hr, at least 4 g of Lewis acid/m²/hr, at least 5 g of Lewis acid/m²/hr, at least 6 g of Lewis acid/m²/hr, at least 7 g of Lewis acid/m²/hr, at least 8 g of Lewis acid/m²/hr, at least 9 g of Lewis acid/m²/hr, at least 10 g of Lewis acid/m²/hr, at least 20 g of Lewis acid/m²/hr, at least 30 g of Lewis acid/m²/hr, at least 40 g of Lewis acid/m²/hr, at least 50 g of Lewis acid/m²/hr, at least 60 g of Lewis acid/m²/hr, at least 70 g of Lewis acid/m²/hr, at least 80 g of Lewis acid/m²/hr, at least 90 g of Lewis acid/m²/hr, at least 100 g of Lewis acid/m²/hr, at least 200 g of Lewis acid/m²/hr, at least 300 g of Lewis acid/m²/hr, at least 400 g of Lewis acid/m²/hr, at least 500 g of Lewis acid/m²/hr, at least 600 g of Lewis acid/m²/hr, at least 700 g of Lewis acid/m²/hr, at least 800 g of Lewis acid/m²/hr, at least 900 g of Lewis acid/m²/hr, or at least 1,000 g of Lewis acid/m²/hr.

Electroswing adsorption cells according to various aspects of the present disclosure are further shown in the Figures and discussed in detail below.

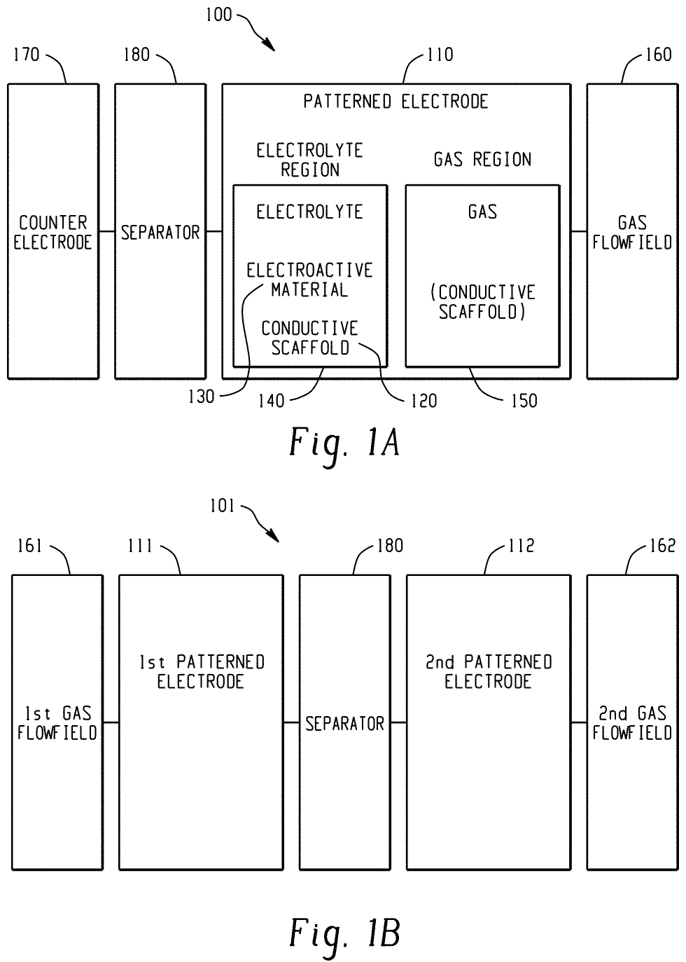

FIG. 1A is a schematic diagram of an asymmetric electroswing adsorption cell 100 with a patterned first electrode 110. The patterned first electrode 110 includes conductive scaffold 120 having an electroactive species 130 disposed thereon, an electrolyte region 140 and a gas region 150. The conductive scaffold 120 extends through and contacts the electrolyte region 140. In an aspect, the conductive scaffold 120 can extend into the gas region 150. In an aspect, the gas region 150 can be free of the conductive scaffold 120. The patterned electrode 110 is coupled to a gas flowfield 160, which delivers a gas stream comprising a target gas species to the patterned electrode 110. The electroswing adsorption cell 100 also includes a counter electrode 170, which can balance the charge of the electroactive species 130 when the electroactive species 130 is reduced. A separator 180 is disposed between the patterned electrode 110 and the counter electrode 170.

In an aspect, it may be desirable to use a second patterned electrode instead of the counter electrode 170 to provide a symmetric electrochemical swing adsorption cell as shown in FIG. 1B. In the symmetric electrochemical swing adsorption cell 101, a first patterned first electrode 111 and a second patterned electrode 112 may be compositionally the same as disclosed for the patterned electrode 110, however in use their state of charge would be different. Similarly, the first gas flow field 161 and the second gas flow field 162 may each independently be as described for the gas flow field 160. The symmetric electrochemical swing adsorption cell may be desirable because it may provide additional efficiencies, for example the first patterned electrode may provide capture while the second patterned electrode may provide release of the target species. Thus, for clarity and ease of description, while an asymmetric cell may be described, a second gas flow field and a second patterned electrode may be used in place of the counter electrode to provide a symmetric cell.

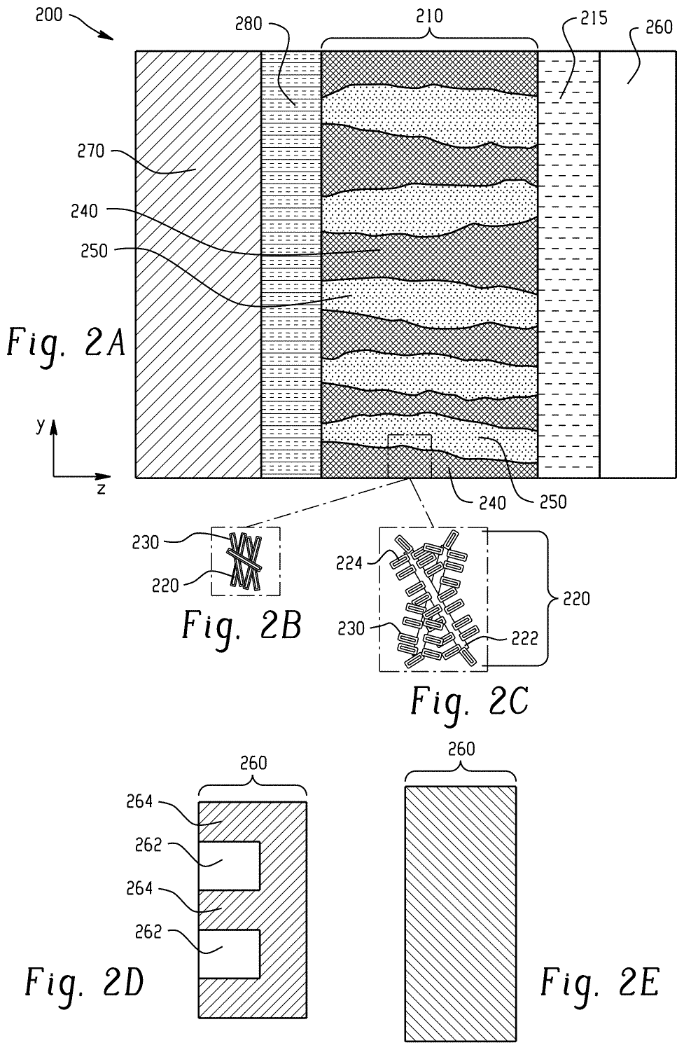

FIG. 2A shows an electroswing adsorption cell 200 with a patterned electrode 210. As shown in FIG. 2A, the patterned electrode 210 includes conductive scaffold 220 having an electroactive species 230 disposed thereon, electrolyte regions 240, and gas regions 250. The electroswing adsorption cell 200 also includes a second electrode 270 and a separator 280. In an aspect, the electroswing adsorption cell 200 may also include a gas diffusion layer 215 between the patterned electrode 210 and the gas flowfield 260.

The capture rate over a multi-phase reaction zone (e.g., the patterned electrode 210) can be approximated via Fick's law according to Equation 1:

$$CR = \frac{2 ( \frac{D ɛ}{τ} ) {c}_{sat}}{{L}_{D} M} \qquad ( 1 )$$

where CR is the capture rate of the Lewis acid by the electroswing adsorption cell 200 (e.g., grams of Lewis acid/m²/hr), ε is the volume fraction of electrolyte in the electrolyte regions 240, D is the diffusivity of the dissolved Lewis gas in the electrolyte (m²/hr), t is the tortuosity (often approximated as ε^{-0.5}), cₛₐₜ is the concentration of dissolved gas in the electrolyte at the interface between the electrolyte region 240 and the gas region 250 where the electrolyte is in equilibrium with the concentration of Lewis gas in the gas phase (mol/m³), M is the molecular mass of the target gas species (g/mol), and L_{D} is the diffusion length, e.g., the average thickness of the electrolyte region 240 in the y direction. Equation 1 shows that the rate at which the electroswing adsorption cell 200 captures gas is inversely proportional to the width of the electrolyte-region 240.

The conductive scaffold 220 can be arranged in a random, irregular pattern, as shown in FIG. 2A, or in an ordered pattern, e.g., as in a woven carbon fiber material. In an aspect, the particles which comprise the conductive scaffold 220 may have a narrow particle-size distribution, as shown in FIG. 2B. In an aspect, the particles in the conductive scaffold 220 may comprise small particles 224, such as nanotubes, vapor grown carbon fiber, or graphene, disposed upon larger fibers 222, such as carbon fiber, as shown in FIG. 2C.

In an aspect, the gas flowfield 260 can include channels 262 and ribs 264, as shown in FIG. 2D. In an aspect, the gas diffusion layer 215 can serve to distribute the gas flow from the channels 262 under the ribs 264. The average widths of the channels 262, the ribs 264, or both (e.g., in the y-direction in FIG. 2D) and the average depths of the channels 262 (e.g., in the z-direction in FIG. 2) can be as described above.

In an aspect, the ribs and channels may be omitted if desired, for example when the gas flowfield 260 comprises a porous metal foam, as shown in FIG. 2E. In an aspect, the gas flowfield 260 can include portions composed of a porous metal foam and portions that include the channels 262 and the ribs 264. In an aspect, a porosity of the gas flow field is greater than a porosity of the gas diffusion layer.

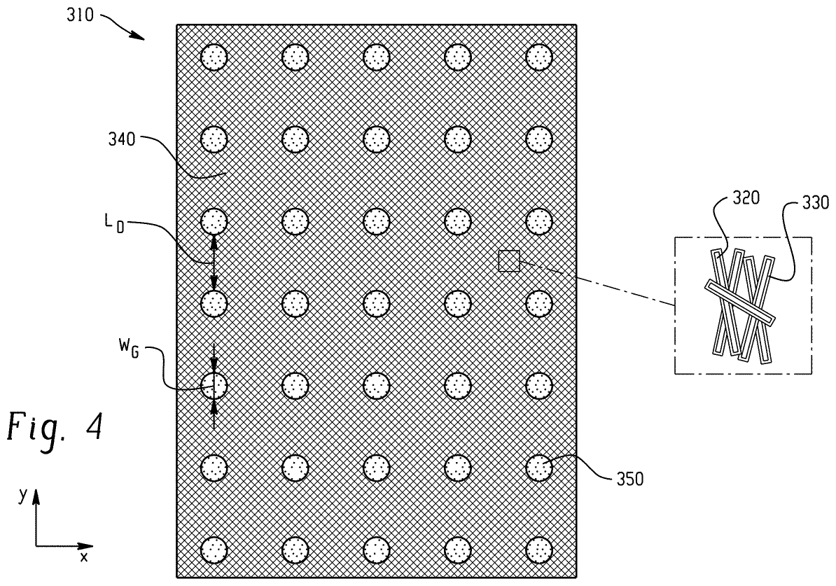

FIGS. 3 and 4 show an electroswing adsorption cell 300 with a patterned electrode 310. FIG. 3 shows a cross-sectional view of the electroswing adsorption cell 300, while FIG. 4 shows a front view of the patterned electrode 310. The patterned electrode 310 includes a conductive scaffold 320 having an electroactive species 330 disposed thereon, electrolyte regions 340, and gas regions 350. The electroswing adsorption cell 300 further includes a gas flowfield 360, a second electrode 370 and a separator 380. In an aspect, the electroswing adsorption cell 300 may include a gas diffusion layer 315 between the patterned electrode 310 and the gas flowfield 360. FIGS. 3 and 4 show gas regions 350 which have a cylindrical or conical shape, however the gas regions may have any suitable shape.

FIGS. 3 and 4 also depict dimensions L_{I}, L_{D}, and W_{G}. L_{I} describes the distance the cation C⁺ migrates from the separator to the active site of the electroactive species P in an ESA cell, e.g., an average distance from the separator 380 to the gas-diffusion layer 315. In other words, L_{I} describes a distance a cation migrates in the electrolyte regions 340 from the separator 380 to an active site in the patterned electrode 310. L_{D} describes the diffusion length of a path of the Lewis acid gas, e.g., an average distance between the gas regions 350. In other words, L_{D} describes a diffusion length of a target gas species through the electrolyte to an active site in the patterned electrode 310. W_{G} describes an average width of the gas regions 350. When the gas regions 350 are spherical or cylindrical in shape, (e.g., as in FIGS. 3 and 4), W_{G} is the diameter of the gas regions 350. When the gas regions 350 include irregular shapes, W_{G} is the volume-averaged width of the gas regions 350.

L_{I}, L_{D} and W_{G} can be as previously described. For example, L_{D} can be 1 μm to 1 mm. For example, W_{G} can be 1 μm to 100 μm. For example, L_{I} can be 15 to 500 μm.

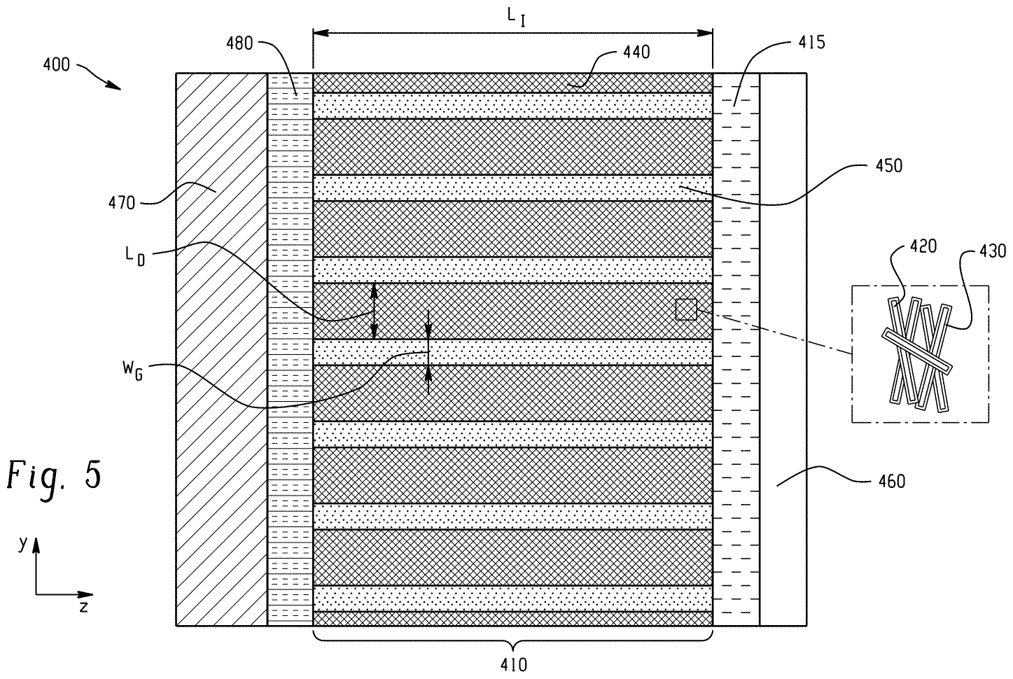

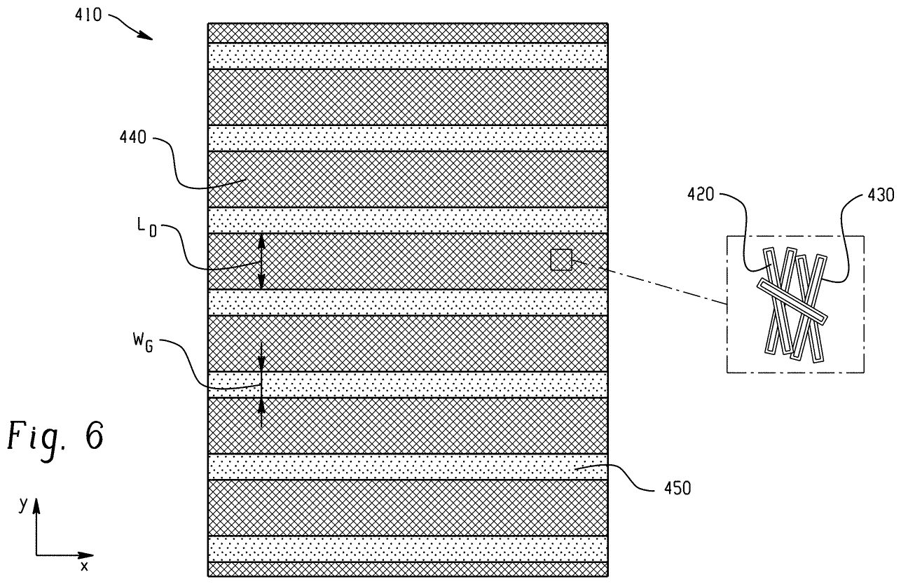

FIGS. 5 and 6 show an electroswing adsorption cell 400 with a patterned electrode 410. FIG. 5 shows a cross-sectional view of the electroswing adsorption cell 400, while FIG. 6 shows a front view of the patterned electrode 410. The patterned electrode 410 includes a conductive scaffold 420 having an electroactive species 430 disposed thereon, electrolyte regions 440, and gas regions 450. The electroswing adsorption cell 400 further includes a gas flowfield 460, a second electrode 470 and a separator 480. In an aspect, the electroswing adsorption cell 400 may include a gas diffusion layer 415 between the patterned electrode 410 and the gas flowfield 460. FIGS. 5 and 6 show gas regions which have a striped or rectangular prism shape.

Included in FIGS. 5 and 6 are dimensions L_{I}, L_{D}, and W_{G}, which have been defined previously.

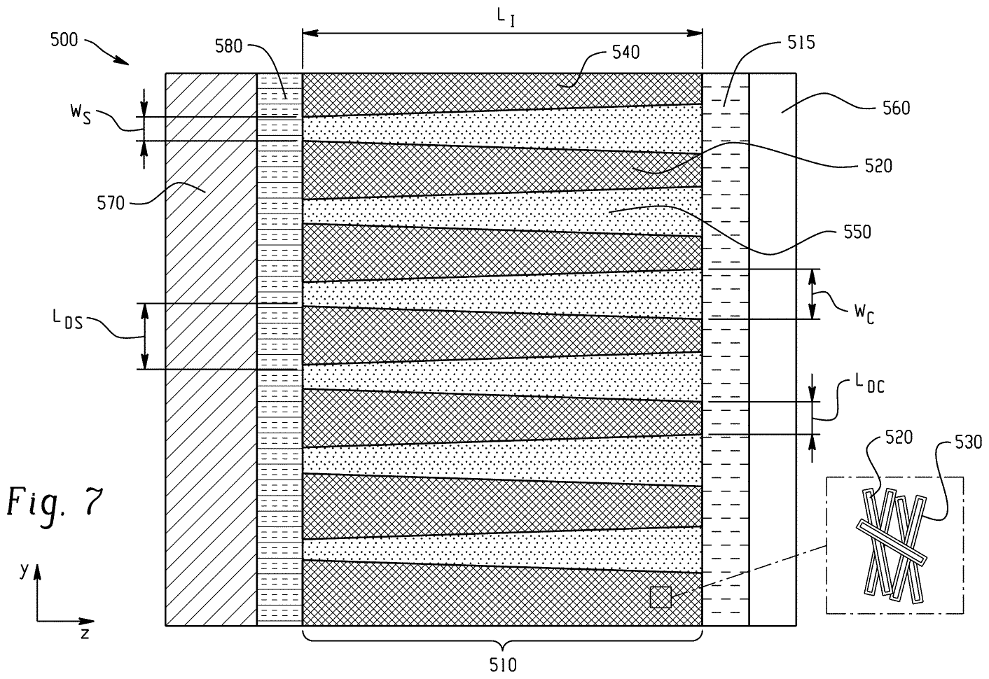

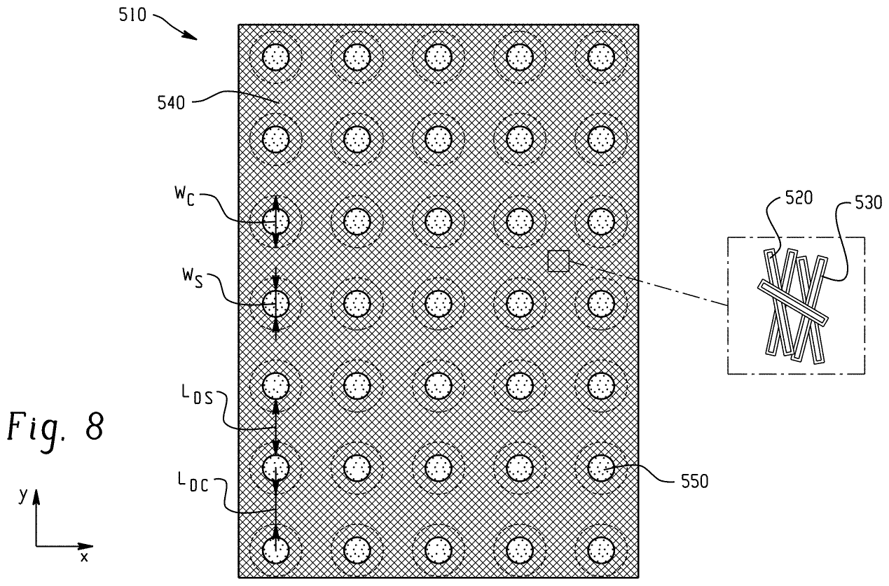

FIGS. 7 and 8 show an electroswing adsorption cell 500 with a patterned electrode 510. FIG. 7 shows a cross-sectional view of the electroswing adsorption cell 500, while FIG. 8 shows a front view of the patterned electrode 510. The patterned electrode 510 includes a conductive scaffold 520 coated in an active polymer 530, electrolyte regions 540, and gas regions 550. The electroswing adsorption cell 500 further includes a gas flowfield 560, a second electrode 570 and a separator 580. In an aspect, the electroswing adsorption cell 500 may include a gas-diffusion layer 515 between the patterned electrode 510 and the gas flowfield 560.

As depicted in FIGS. 7 and 8, the gas regions 550 of the patterned electrode 510 are broader near the gas flowfield 560 and narrower near the separator 580. In other words, the gas regions 550 have a trapezoidal cross-section. Conversely, the electrolyte regions 540 may be broader near the separator 580 and narrower near the gas flowfield 560. Without wishing to be bound by theory, the overall resistance of the electroswing adsorption cell 500 contains contributions from ionic resistivity in the electrolyte, electrical resistivity in the conductive scaffold 520, charge transfer, and diffusion of the Lewis acid. While not wanting to be bound by theory, it is understood that at the separator 580, all of the current is carried by ions. As the current travels across the patterned electrode 510, it is transferred by electrochemical reaction from ions in the electrolyte phase to electrons in the conductive scaffold 520. At the gas flowfield 560, all of the current is carried by electrons. Ionic resistance is proportional to current density divided by the volume fraction of the electrolyte. Therefore, overall cell resistance of the electroswing adsorption cell 500 can be reduced by having a larger volume fraction of electrolyte near the separator 580. Including more electrolyte near the separator 580 can facilitate movement of ions transported from the counter electrode 570. Additionally, geometries with gas regions 550 broader near the gas flowfield 560 and narrower near the separator 580 can be easier to manufacture and can reduce the risk of defects blocking gas flow paths.

In an aspect, L_{I} can have the same or substantially similar properties/dimensions as described above. L_{DS} describes a diffusion length of a target gas species to an active site in the patterned electrode 510 near the interface between the patterned electrode 510 and the separator 580. L_{DC} describes a diffusion length of a target gas species to an active site in the patterned electrode 510 near the interface between the patterned electrode 510 and the gas-diffusion layer 515. W_{S} describes an average width of the gas regions 550 near the interface between the patterned electrode 510 and the separator 580. W_{C} describes an average width of the gas regions 550 near the interface between the patterned electrode 510 and the gas-diffusion layer 515. In an aspect, W_{S} can have the same or substantially similar dimensions to W_{G}.

In an aspect, W_{C} can be 1 to 500 μm. Within this range, W_{C} can be at least 1 μm, at least 2 μm, at least 3 μm, at least 4 μm, at least 5 μm, at least 6 μm, at least 7 μm, at least 8 μm, at least 9 μm, at least 10 μm, at least 20 μm, at least 30 μm, at least 40 μm, at least 50 μm, at least 60 μm, at least 70 μm, at least 80 μm, at least 90 μm, at least 100 μm, at least 150 μm, at least 200 μm, at least 250 μm, at least 300 μm, at least 350 μm, at least 400 μm, or at least 450 μm. Also within this range, W_{C} can be no more than 500 μm, no more than 450 μm, no more than 400 μm, no more than 350 μm, no more than 300 μm, no more than 250 μm, no more than 200 μm, no more than 150 μm, no more than 100 μm, no more than 90 μm, no more than 80 μm, no more than 70 μm, no more than 60 μm, no more than 50 μm, no more than 40 μm, no more than 30 μm, no more than 20 μm, no more than 10 μm, no more than 9 μm, no more than 8 μm, no more than 7 μm, no more than 6 μm, no more than 5 μm, no more than 4 μm, no more than 3 μm, or no more than 2 μm. Combinations of the above-referenced W_{C} values for the gas region are also possible.

In an aspect, L_{DC} can be 1 μm to 1 mm. Within this range, L_{DC} can be at least 1 μm, at least 2 μm, at least 3 μm, at least 4 μm, at least 5 μm, at least 6 μm, at least 7 μm, at least 8 μm, at least 9 μm, at least 10 μm, at least 20 μm, at least 30 μm, at least 40 μm, at least 50 μm, at least 60 μm, at least 70 μm, at least 80 μm, at least 90 μm, at least 100 μm, at least 200 μm, at least 300 μm, at least 400 μm, at least 500 μm, at least 600 μm, at least 700 μm, at least 800 μm, or at least 900 μm. Also within this range, L_{DC} can be no more than 1 mm, no more than 900 μm, no more than 800 μm, no more than 700 μm, no more than 600 μm, no more than 500 μm, no more than 400 μm, no more than 300 μm, no more than 200 μm, no more than 100 μm, no more than 90 μm, no more than 80 μm, no more than 70 μm, no more than 60 μm, no more than 50 μm, no more than 40 μm, no more than 30 μm, no more than 20 μm, no more than 10 μm, no more than 9 μm, no more than 8 μm, no more than 7 μm, no more than 6 μm, no more than 5 μm, no more than 4 μm, no more than 3 μm, or no more than 2 μm. Combinations of the above-referenced ranges for L_{DC} are also possible.

In an aspect, L_{DS} can be 1 μm to 1.5 mm. Within this range, L_{DS} can be at least 1 μm, at least 2 μm, at least 3 μm, at least 4 μm, at least 5 μm, at least 6 μm, at least 7 μm, at least 8 μm, at least 9 μm, at least 10 μm, at least 20 μm, at least 30 μm, at least 40 μm, at least 50 μm, at least 60 μm, at least 70 μm, at least 80 μm, at least 90 μm, at least 100 μm, at least 200 μm, at least 300 μm, at least 400 μm, at least 500 μm, at least 600 μm, at least 700 μm, at least 800 μm, or at least 900 μm, at least 1 mm, at least 1.1 mm, at least 1.2 mm, at least 1.3 mm, or at least 1.4 mm. Also within this range, L_{DS} can be no more than 1.5 mm, no more than 1.4 mm, no more than 1.3 mm, no more than 1.2 mm, no more than 1.1 mm, no more than 1 mm, no more than 900 μm, no more than 800 μm, no more than 700 μm, no more than 600 μm, no more than 500 μm, no more than 400 μm, no more than 300 μm, no more than 200 μm, no more than 100 μm, no more than 90 μm, no more than 80 μm, no more than 70 μm, no more than 60 μm, no more than 50 μm, no more than 40 μm, no more than 30 μm, no more than 20 μm, no more than 10 μm, no more than 9 μm, no more than 8 μm, no more than 7 μm, no more than 6 μm, no more than 5 μm, no more than 4 μm, no more than 3 μm, or no more than 2 μm. Combinations of the above-referenced ranges for L_{DS} are also possible.

In an aspect, W_{c}/Wₛ can be 1 to 10 (i.e., 1/1 to 10/1). Within this range, W_{c}/Wₛ can be at least 1, at least 1.1, at least 1.2, at least 1.3, at least 1.4, at least 1.5, at least 1.6, at least 1.7, at least 1.8, at least 1.9, at least 2, at least 2.1, at least 2.2, at least 2.3, at least 2.4, at least 2.5, at least 2.6, at least 2.7, at least 2.8, at least 2.9, at least 3, at least 3.5, at least 4, at least 5, at least 6, at least 7, at least 8, or at least 9. Also within this range, W_{c}/Wₛ can be no more than 10, no more than 9, no more than 8, no more than 7, no more than 6, no more than 5, no more than 4, no more than 3.5, no more than 3, no more than 2.9, no more than 2.8, no more than 2.7, no more than 2.6, no more than 2.5, no more than 2.4, no more than 2.3, no more than 2.2, no more than 2.1, no more than 2, no more than 1.9, no more than 1.8, no more than 1.7, no more than 1.6, no more than 1.5, no more than 1.4, no more than 1.3, no more than 1.2, or no more than 1.1. Combinations of the above-referenced values for W_{c}/Wₛ are also possible.

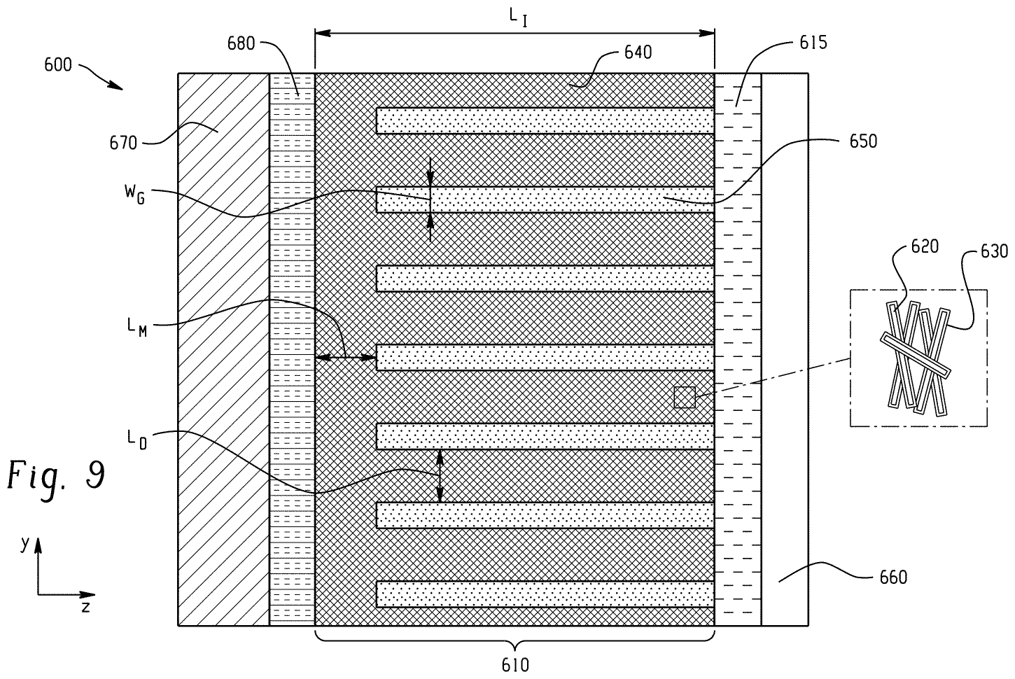

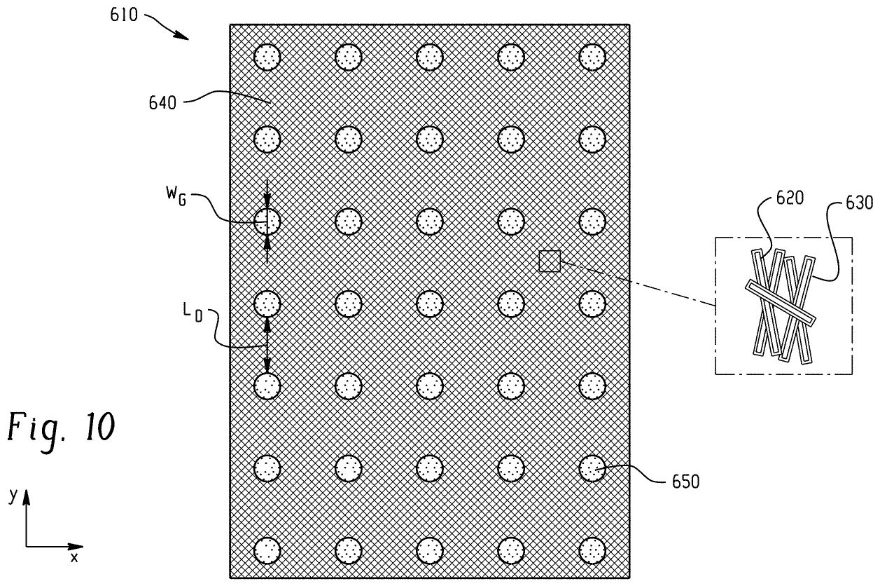

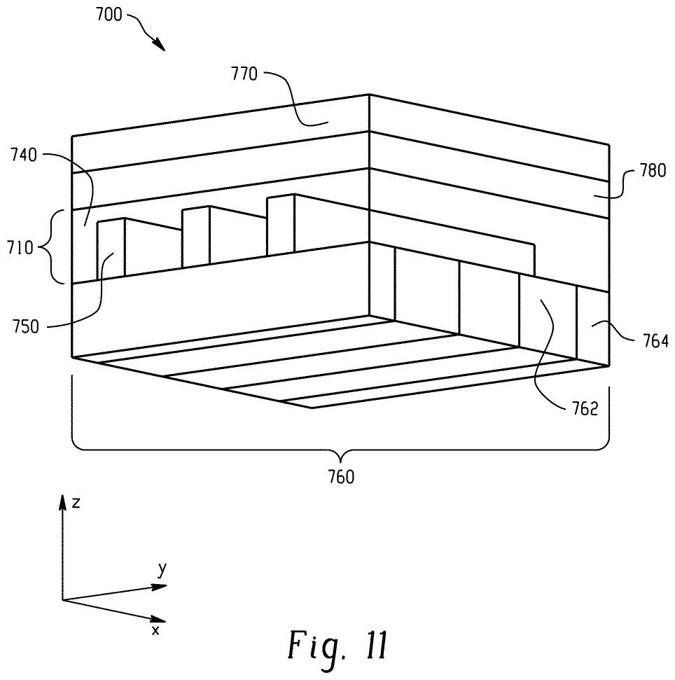

FIGS. 9 and 10 show an electroswing adsorption cell 600 with a patterned electrode 610. FIG. 9 shows a cross-sectional view of the electroswing adsorption cell 600, while FIG. 10 shows a front view of the patterned electrode 610. The patterned electrode 610 includes a conductive scaffold 620 having an electroactive species 630 disposed thereon, electrolyte regions 640, and gas regions 650. The electroswing adsorption cell 600 further includes a gas flowfield 660, a second electrode 670 and a separator 680. In an aspect, the electroswing adsorption cell 600 may include a gas diffusion layer 615 between the patterned electrode 610 and the gas flowfield 660.

As depicted in FIGS. 9 and 10, the patterned electrode 610 includes dimensions L_{I}, W_{G}, L_{D}, and L_{M}. L_{I}, W_{G}, and L_{D} can be as described above.

L_{M} defines the length of an electrolyte filled region covering the separator 680. L_{M} can be about half of L_{D}. In an aspect, L_{M} can be 0 to 30 μm. Within this range, L_{M} can be at least 0 μm, at least 1 μm, at least 2 μm, at least 3 μm, at least 4 μm, at least 5 μm, at least 6 μm, at least 7 μm, at least 8 μm, at least 9 μm, at least 10 μm, at least 11 μm, at least 12 μm, at least 13 μm, at least 14 μm, at least 15 μm, at least 16 μm, at least 17 μm, at least 18 μm, at least 19 μm, at least 20 μm, at least 21 μm, at least 22 μm, at least 23 μm, at least 24 μm, at least 25 μm, at least 26 μm, at least 27 μm, at least 28 μm, or at least 29 μm. Also within this range, L_{M} can be no more than 30 μm, no more than 29 μm, no more than 28 μm, no more than 27 μm, no more than 26 μm, no more than 25 μm, no more than 24 μm, no more than 23 μm, no more than 22 μm, no more than 21 μm, no more than 20 μm, no more than 19 μm, no more than 18 μm, no more than 17 μm, no more than 16 μm, no more than 15 μm, no more than 14 μm, no more than 13 μm, no more than 12 μm, no more than 11 μm, no more than 10 μm, no more than 9 μm, no more than 8 μm, no more than 7 μm, no more than 6 μm, no more than 5 μm, no more than 4 μm, no more than 3 μm, no more than 2 μm, or no more than 1 μm. Combinations of the above-referenced L_{M} values are also possible.

FIG. 11 shows a 3-dimensional rendering of an electroswing adsorption cell 700 with a patterned electrode 710. The patterned electrode 710 includes electrolyte regions 740 and gas regions 750. The electroswing adsorption cell 700 further includes a gas flowfield 760 with gas channels 762 and ribs 764. The electroswing adsorption cell 700 also includes a second electrode 770 and a separator 780. In an aspect, the gas regions 750 can have a rectilinear cross sectional shape, e.g., a rectangular or prismatic shape. In an aspect, the gas channels 762 can have a rectangular prism shape. Note that FIG. 11 is not to scale. For example, the width of the ribs 764 and channels 762 can be on the order of millimeters as described previously, whereas the width of the gas regions 750 and electrolyte regions 740 are given by W_{G} and L_{D}, respectively.

The gas regions 750 are oriented perpendicular to the orientation of the gas channels 762, thereby facilitating gas flow from the gas channel 762 parallel to the separator 780. This aspect can be particularly advantageous when the flowfield 760 has an interdigitated flow arrangement, in which inlet channels alternate with outlet channels. For example, in FIG. 11, one of the two channels shown would be an inlet channel, while the other would be an outlet channel. It is understood that FIG. 11 is a subset of a cell; a cell may contain multiple inlet channels and outlet channels. In the configuration shown in FIG. 11, the gas diffusion layer is omitted, in order to force gas convection through the gas regions. A function of the gas diffusion layer can be to provide a compressible material that can accommodate manufacturing thickness variability in the cell components (electrode, separator, ribs, and current collector). In embodiments which lack a gas diffusion layer, it may be advantageous for the ribs to be comprised of a compressible material such as electrically conductive closed-cell foam or gasket.

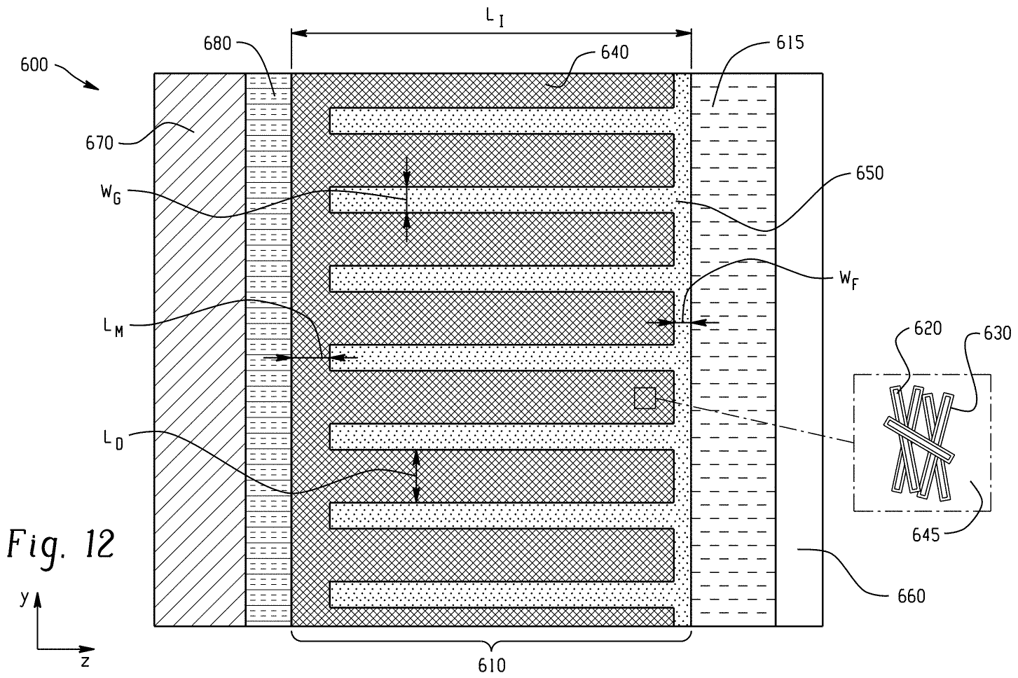

FIG. 12 shows an electroswing adsorption cell 600 with a patterned electrode 610. The patterned electrode 610 includes an electrolyte region 640 comprising a conductive scaffold 620 having an electroactive species 630 disposed thereon, an electrolyte 645 disposed within the electrolyte region; and gas regions 650. The electroswing adsorption cell 600 further includes a gas flowfield 660, a second electrode 670, a separator 680, and a gas-diffusion layer 615. The patterned electrode 610 can be assembled by pleating or folding the electrolyte region 640 with the gas region 650. As shown in FIG. 12, folding the electrolyte region 640 with the gas region 650 results in formation of a layer of gas region 650 between the electrolyte region and the flowfield (e.g., the electrolyte region does not contact the flow field). Similarly, folding the electrolyte region 640 with the gas region 650 results in formation of a layer of electrolyte region 640 between the gas region and the separator (e.g., the gas region does not contact the separator). Also shown in FIG. 12 is the cation migration distance L_{I} and the width of the gas region W_{G}. For the folded or pleated electrode configuration described in FIG. 12, W_{G} can be twice the thickness of the gas region 650 in an unfolded state W_{F}. Shown in FIG. 12 is the diffusion length L_{D} for the patterned electrode 610, which can be twice the thickness of the electrolyte region 640 in an unfolded state L_{M}. In an aspect, L_{I}, W_{G}, and L_{D} can be the same or substantially similar to L_{I}, W_{G}, and L_{D}, respectively, as described above with reference to FIGS. 3 and 4. In an aspect, W_{G} and L_{D} may be constant in the z direction. In an aspect, W_{G} and L_{D} may vary in the z direction.

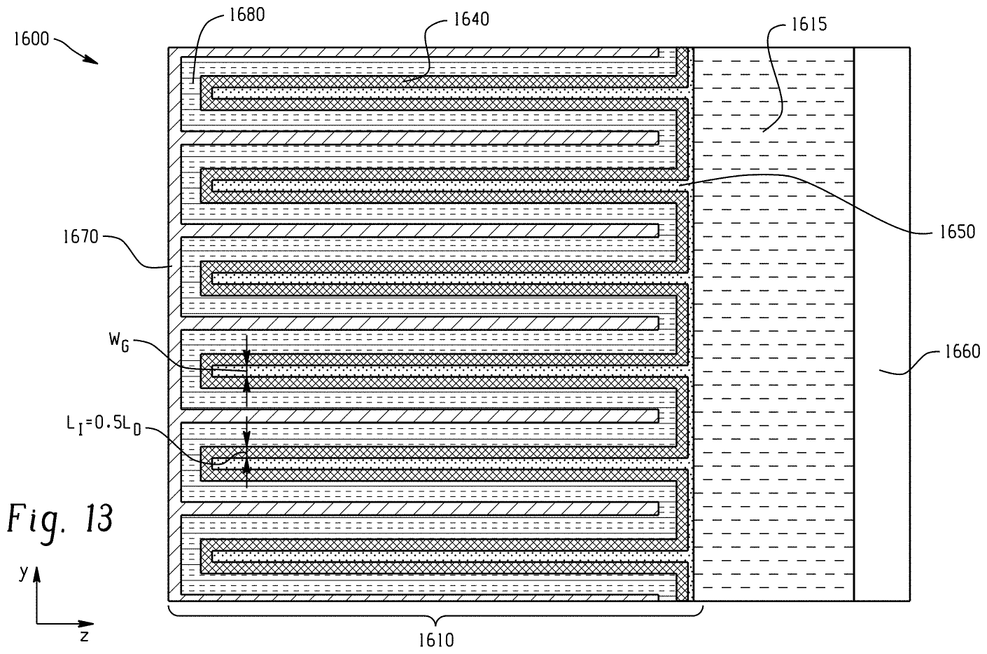

FIG. 13 shows an electroswing adsorption cell 1600 with a patterned electrode-separator assembly 1610. The patterned electrode-separator assembly 1610 includes an electrolyte region 1640 comprising a conductive scaffold having an electroactive species disposed thereon and an electrolyte; gas region 1650, a second electrode 1670, and a separator 1680. The electroswing adsorption cell 1600 further includes a gas flowfield 1660 and an optional gas diffusion layer 1615. The patterned electrode-separator assembly 1610 can be assembled by placing the electrolyte region 1640 onto the separator 1680; placing the gas region 1650 on top of the electrolyte region 1640; placing a second electrode 1670 on the opposite side of the separator 1680 to provide the electrode-separator assembly 1610. The electrode-separator assembly 1610 can be pleated or folded. The patterned electrode-separator assembly 1610 can then be combined with the gas diffusion layer 1615 and flowfield 1660 to provide the cell 1600.

An electroswing adsorption cell according to the present disclosure can include any combination of features described above, with reference to FIGS. 1-13. For example, those skilled in the art of flowfield design would recognize that combinations of embodiments are possible. For example, the cell of FIG. 11, containing flow channels oriented perpendicular to gas regions, could be combined with the patterned electrode of FIG. 12 or FIG. 13, with the electrolyte region 640 or 1640 of FIG. 12 or FIG. 13, respectively, oriented perpendicular to the flow channels of FIG. 11.

A method of producing the above described patterned electrode represents another aspect of the present disclosure. In an aspect, the electrode comprising the plurality of electrolyte regions, plurality of gas regions, and the conductive scaffold can be produced by depositing a composite material onto a separator or gas diffusion layer, the composite material comprising an electrolyte and the conductive scaffold coated with the electroactive species and forming the electrode comprising the plurality of electrolyte regions and the plurality of gas regions.

In an aspect, the composite material deposited on the sacrificial carrier film or the separator can include electroactive species, electronically conductive particles, electrolyte, and sacrificial porogen. In an aspect, the composite mixture can be a bicontinuous emulsion. In an aspect, the composite material deposited can include a mixture of an electroactive species, electronically conductive particles and electrolyte. In an aspect, the composite material can include an electroactive species, a cross-linking agent, conductive particles, and a carrier solvent. In an aspect, the composite can include an electroactive polymer for forming a gel with the electrolyte. In an aspect, the electrolyte can be contained in the composite material by capillary action.

The composite material deposited can include an electronically conductive scaffold. In an aspect, the electronically conductive scaffold can have a very high surface energy with the electrolyte (e.g., the electronically conductive scaffold can be ionophobic, e.g., not wettable by the electrolyte). In an aspect, the electronically conductive scaffold can include one or more inks printed onto the electronically conductive scaffold. In an aspect, a first ink can include an electrolyte and a thermally initiated precursor for forming a gel. In an aspect, the first ink can include an electroactive species in a carrier solvent. In an aspect, the first ink can include an ionophilic active material with a crosslinker. In an aspect, a second ink can include a sacrificial pore former. In an aspect, the pore former can include a wax with a low melting point. In an aspect, the composite material deposited can include an electronically conductive scaffold coated with an electroactive species and filled with electrolyte containing polymer precursors.

Depositing the composite material on the sacrificial carrier film or the separator can be accomplished by various methods which are generally known including, but not limited to, coating, spray coating, uniform coating, slot-die coating, gravure coating, ink-jet printing, 3-D printing, extrusion, co-extrusion of multiple phases, or any combination thereof. The electrode can be assembled using one or more coating layers. In an aspect, a pattern can be formed by coating, extruding, or printing two inks, wherein one ink comprises electronically conductive scaffold, active material, electrolyte, and gel former; and the second ink comprises a sacrificial porogen. In an aspect, the composite material can be uniformly filled into pores of an ionophobic electronically conductive scaffold.

In an aspect, the composite material can optionally undergo a chemical reaction, preferably prior to removal of a portion of the composite material, as described in detail above. In an aspect, the chemical reaction can form regions of ionophobicity (i.e., regions that repel the electrolyte) and regions ionophilicity (i.e., regions that attract the electrolyte). In an aspect, the chemical reaction can include formation of a gel from a reaction between the electrolyte and an electroactive species. In an aspect, an electroactive material precursor can undergo patterned crosslinking to form an electroactive material. In an aspect, crosslinking can occur selectively to only produce crosslinked material in desired regions of the composite material, such that uncrosslinked material can be removed. In an aspect, crosslinking can be induced, for example, by ultraviolet (UV) radiation, infrared (IR) radiation, thermal radiation, patterned thermal radiation, a chemical reagent, or any combination thereof. In an aspect, the application of heat can polymerize active material precursors to form a gel. In an aspect, selective crosslinking can be induced by the use of masks, lithography, interference patterns, patterned thermal radiation, or any combination thereof. In an aspect, the method can include treating the electrolyte and electroactive species with a reagent to form ionogel filling pores of a conductive scaffold.

In an aspect, the electroactive species can become ionophobic upon exposure to a reagent. In an aspect, the reagent can include radiation (e.g., by UV light, e-beam, infrared, and the like) or a chemical reagent. The reagent can be applied through a patterned mask to form a pattern of ionophilic and ionophobic regions in the composite material (i.e., form a patterned electrode). The coating can include an electroactive material precursor, a cross-linking agent, conductive particles, and a carrier solvent. In an aspect, the electroactive active material precursor can undergo patterned crosslinking, as discussed above.

The method can further comprise adding a reagent to the composite material to form a first phase and a second phase, wherein the portion of the composite material removed to form the patterned electrode is the second phase. The first phase can comprise a crosslinked electrode material and the second phase comprises an un-crosslinked electrode precursor. The reagent can be a crosslinker added in a patterned configuration by masks, lithography, interference patterns, patterned thermal radiation, or a combination thereof.

The method can include removing a portion of the composite material to form the patterned electrode. This can include removal of the sacrificial porogen. In an aspect, the sacrificial porogen can be removed, for example, by evaporation, rinsing dissolution, decomposition, melting, or any suitable chemical or physical removal method or combination thereof. In an aspect, removal of a portion of the composite material can include laser ablation, lithography, mechanical impression, or any combination thereof. In an aspect, removal of a portion of the composite material can include rinsing the composite material with a solvent that washes away un-crosslinked electrode precursor but does not remove crosslinked active material. In an aspect, removal of a portion of the composite material can include the application of heat to evaporate the sacrificial pore former. In an aspect, removal of a portion of the composite material can include dissolving and rinsing the sacrificial pore former with a solvent. Removal of a porogen by dissolution is further described in the working examples below.

In an aspect, the chemical reaction step can occur partially or fully simultaneously with the removal step. For example, application of heat can simultaneously polymerize the gel former in the electrolyte while evaporating the sacrificial pore former.

In an aspect, the electrolyte can be included or deposited with the composite material. In an aspect, the electrolyte can be added after removing the portion of composite materials to form the patterned electrode.

In an aspect, a printer can print a pattern with two inks into a scaffold. A first ink can include an active material and an ionophilic compound. The ionophilic compound can be physically mixed with an electroactive species. The ionophilic compound can be incorporated into an electroactive polymer via copolymerization. A second ink can include an ionophobic compound which renders regions of the scaffold ionophobic. The scaffold can be ionophilic. In an aspect, the first ink can include an electroactive species while the second ink can include an ionophobic compound that renders regions of the scaffold ionophobic. The scaffold with the inks can be disposed onto the sacrificial carrier film or the separator, prior to deposition of the composite material. The scaffold can then be coupled to the gas flowfield and the counter electrode to form the electroswing adsorption cell.

In an aspect, removing a portion of the composite material can leave pores behind. In an aspect, the pores can be gas-filled pores. In an aspect, the pores can be percolating gas-filled pores. In an aspect the pores can be air-filled pores. In an aspect, the pores can have a conical shape, a conical frustrum shape, a spherical shape, a striped shape, a rectangular prism shape, an irregular shape, an amorphous shape, or any combination thereof.

A method of producing an electroswing adsorption cell represents another aspect of the present disclosure.

In an aspect, the electroswing adsorption cell can be produced by depositing a composite material onto a separator, the composite material comprising an electrolyte and a conductive scaffold coated with an electroactive species; forming a first electrode comprising a plurality of electrolyte regions and a plurality of gas regions (e.g., a patterned first electrode); and coupling a gas flowfield and a second electrode to the patterned first electrode to provide the electroswing adsorption cell.

In an aspect, the composite material deposited on the sacrificial carrier film or the separator can include electroactive species, electronically conductive particles, electrolyte, and sacrificial porogen. In an aspect, the composite mixture can be a bicontinuous emulsion. In an aspect, the composite material deposited can include a mixture of an electroactive species, electronically conductive particles and electrolyte. In an aspect, the composite material can include an electroactive species, a cross-linking agent, conductive particles, and a carrier solvent. In an aspect, the composite can include an electroactive polymer for forming a gel with the electrolyte. In an aspect, the electrolyte can be contained in the composite material by capillary action.

The composite material deposited can include an electronically conductive scaffold. In an aspect, the electronically conductive scaffold can have a very high surface energy with the electrolyte (e.g., the electronically conductive scaffold can be ionophobic, e.g., not wettable by the electrolyte). In an aspect, the electronically conductive scaffold can include one or more inks printed onto the electronically conductive scaffold. In an aspect, a first ink can include an electrolyte and a thermally initiated precursor for forming a gel. In an aspect, the first ink can include an electroactive species in a carrier solvent. In an aspect, the first ink can include an ionophilic active material with a crosslinker. In an aspect, a second ink can include a sacrificial pore former. In an aspect, the pore former can include a wax with a low melting point. In an aspect, the composite material deposited can include an electronically conductive scaffold coated with an electroactive species and filled with electrolyte containing polymer precursors.

Depositing the composite material on the sacrificial carrier film or the separator can be accomplished by various methods which are generally known including, but not limited to, coating, uniform coating, slot-die coating, gravure coating, ink-jet printing, 3-D printing, extrusion, co-extrusion of multiple phases, or any combination thereof, as described above.

In an aspect, the composite material can optionally undergo a chemical reaction, preferably prior to removal of a portion of the composite material, as described in detail above. In an aspect, the electroactive species can become ionophobic upon exposure to a reagent, as described in detail above. The method can further comprise adding a reagent to the composite material to form a first phase and a second phase, wherein the portion of the composite material removed to form the patterned electrode is the second phase, as described in detail above. The method can include removing a portion of the composite material to form the patterned electrode, as described in detail above.

Removing a portion of the composite material can leave pores behind. In an aspect, the pores can be gas-filled pores. In an aspect, the pores can be percolating gas-filled pores. In an aspect the pores can be air-filled pores. In an aspect, the pores can have a conical shape, a conical frustrum shape, a spherical shape, a striped shape, a rectangular prism shape, an irregular shape, an amorphous shape, or any combination thereof.

The method of producing the electroswing adsorption cell further comprises coupling the patterned electrode to the separator, gas flowfield, and the counter electrode to form the electroswing adsorption cell.

In an aspect, an electroswing adsorption cell comprising a patterned first electrode having a pleated or folded configuration can be provided by providing a composite layer comprising an electrolyte and a first conductive scaffold coated with an electroactive species; providing a second conductive scaffold comprising gas-filled pores; pleating the composite layer with the second composite layer to provide a patterned first electrode; and coupling a gas flowfield, a separator, and a second electrode to the patterned first electrode to provide the electrochemical swing adsorption cell having a pleated or folded configuration.

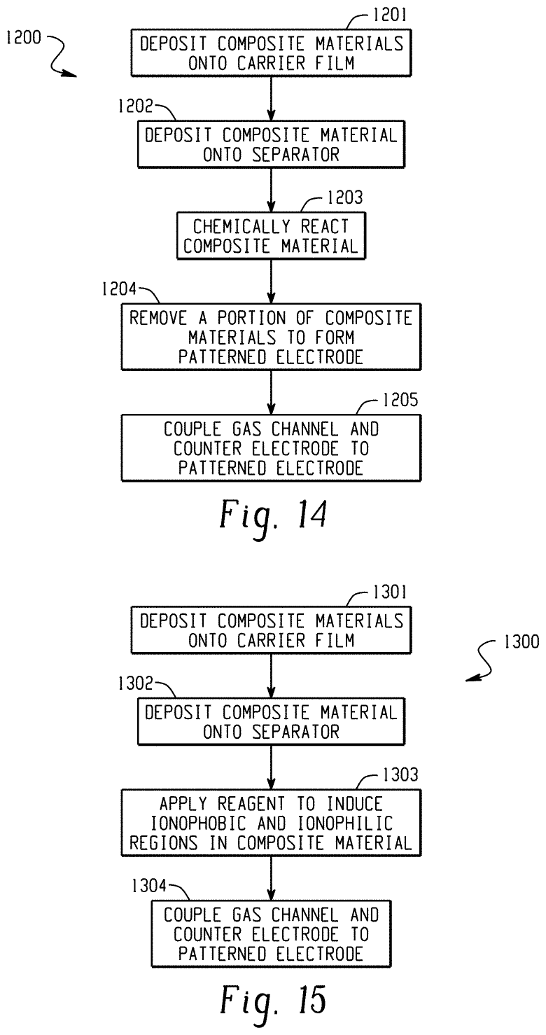

Methods for the manufacture of the patterned electrode and the electroswing adsorption cells according to the present disclosure are further described in FIGS. 14 to 19, and in the examples below.

FIG. 14 shows a method 1200 of forming an electroswing adsorption cell. The method 1200 optionally includes depositing composite materials onto a sacrificial carrier film at step 1201. The method 1200 includes depositing the composite material onto a separator at step 1202, then removing the carrier film. The method 1200 optionally includes chemically reacting the composite material at step 1203. The method 1200 includes removal of a portion of the composite material to form a patterned electrode at step 1204 and coupling a gas flowfield and a second electrode to the patterned electrode at step 1205 to form the cell.

FIG. 15 shows a method 1300 of forming an electroswing adsorption cell. The method 1300 optionally includes depositing composite materials onto a sacrificial carrier film at step 1301. The method 1300 includes depositing the composite material onto a separator at step 1302, either with or without the sacrificial carrier film between the composite material and the separator. The method 1300 optionally includes applying a reagent to induce ionophobic and ionophilic regions in the composite material at step 1303. The method 1300 includes coupling a gas flowfield and a counter electrode to the patterned electrode at step 1304 to form the cell.

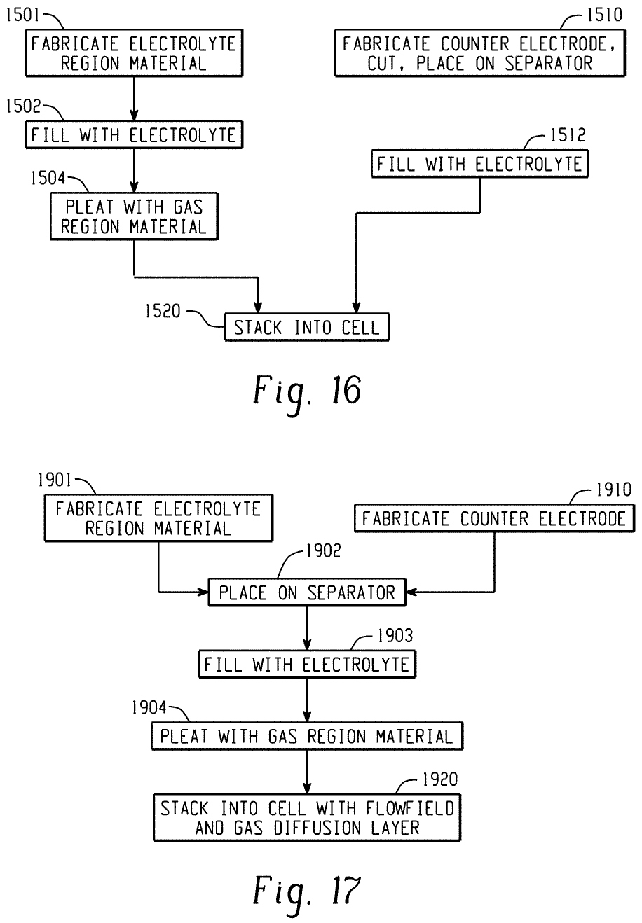

FIG. 16 shows a method 1500 of forming an electroswing adsorption cell. In step 1501, the electroactive material is combined with an electrically conductive scaffold material to make a porous composite active layer, which can serve as the electrolyte region. The pores of the active layer can be filled with electrolyte in step 1502. Optionally, this step may include a gel former, followed by treatment with heat and/or UV light to form a gel electrolyte. A layer of active material and a layer of gas-containing material are pleated to form the patterned electrode. The patterned electrode can be stacked at step 1520 into a cell along with a second electrode made in step 1510, separator, optional gas-diffusion layer, and flowfield to provide the cell.

FIG. 17 shows a method 1900 of forming an electroswing adsorption cell. In step 1901, the electroactive material is combined with an electrically conductive scaffold material to make a porous composite active layer which can serve as the electrolyte region. The active layer can be placed on a separator, and a second electrode can be placed opposite the active layer, in step 1902. The pores of the active layer, separator, and counter electrode can be filled with electrolyte in step 1903. The electrode-separator-electrode assembly can be pleated with a layer of gas-containing material in step 1904 to make the pleated electrode-separator assembly. The electrode-separator assembly can be stacked at step 1920 into a cell along with a gas-diffusion layer and flowfield.

The electroswing adsorption cell can be particularly useful for the separation of a target gas from a gas mixture when the gas mixture is contacted with the electroswing adsorption cell, and thus is particularly well suited for use in a gas separation system. The gas separation system comprises a plurality of electroswing adsorption cells in fluid communication with a gas inlet and a gas outlet.

The gas mixture, also referred to as the input gas, can be at least partially separated upon exposure to the electroswing adsorption cell. The gas mixture can be, for example, ambient air (e.g., air from an ambient environment, such as outdoor air). In an aspect, the gas separation system can be used for direct air capture. The systems and methods described herein can be useful for removing a target gas such as carbon dioxide directly from ambient air (e.g., to reduce greenhouse gas levels), without the need for any pre-concentration step. Certain aspects of the present disclosure can make the systems and methods described herein particularly useful for direct air capture (e.g., an ability to bond with a target gas while being thermodynamically disfavored from reacting with major components of ambient air, such as oxygen).

In an aspect the amount of target gas in a treated gas mixture (e.g., a gas mixture from which an amount of the target gas is removed upon being exposed to the electroswing adsorption cell) is less than or equal to 50%, less than or equal to 25%, less than or equal to 10%, less than or equal to 5%, less than or equal to 2%, less than or equal to 1%, less than or equal to 0.5%, less than or equal to 0.1% of the amount (in volume percent) of the target gas in the original gas mixture prior to treatment (e.g., the amount of the target in the gas mixture prior to being exposed to electroswing adsorption cell). In an aspect, the amount of target gas in a treated gas mixture is greater than or equal to 0.001%, greater than 0.005%, greater than or equal to 0.01%, greater than or equal to 0.05%, greater than or equal to 0.1%, greater than or equal to 0.5%, greater than or equal to 1%, greater than or equal to 2%, greater than or equal to 5% of the amount (in volume percent) of the target gas in the original gas mixture prior to treatment. In an aspect, the concentration of the target gas in the gas mixture is relatively low, for example when the gas mixture is ambient air. For example, the concentration of the target gas in the gas mixture prior to exposure to the electroswing adsorption cell can be less than or equal to 500 ppm, or less than or equal to 450 ppm, or less than or equal to 400 ppm, or less than or equal to 350 ppm, or less than or equal to 300 ppm, or less than or equal to 200 ppm. In an aspect, the concentration of the target gas in the gas mixture can be as low as 100 ppm, or as low as 50 ppm, or as low as 10 ppm.

In an aspect, the gas mixture (e.g., input gas mixture) is ventilated air. The ventilated air can be air in an enclosed or at least partially enclosed place (e.g., air being circulated in an enclosed place). Examples of places in which the gas mixture (e.g., ventilated air) can be located include, but are not limited to sealed buildings, partially ventilated places, car cabins, inhabited submersibles, air crafts, medical and personal ventilation devices, and the like.

The concentration of target gas in the ventilated air can be higher than ambient air but lower than concentrations typical for industrial processes. In an aspect, the concentration of the target gas in the gas mixture prior to exposure to the electroswing adsorption cell is less than or equal to 5,000 ppm, or less than or equal to 4,000 ppm, or less than or equal to 2,000 ppm, or less than or equal to 1,000 ppm. In an aspect, the concentration of the target gas in the gas mixture (e.g., when it is ventilated air or air in enclosed spaces) is as low as 1,000 ppm, or as low as 800 ppm, or as low as 500 ppm, or as low as 200 ppm, or as low as 100 ppm, or as low as 10 ppm.

In an aspect, the gas mixture comprises oxygen gas (02). In an aspect, the gas mixture has a relatively high concentration of oxygen gas (e.g., prior to exposure to the electroswing adsorption cell). Certain aspects of the systems and methods described herein (e.g., the choice of particular electroactive species, methods of handling gases in the system, etc.) can contribute to an ability to capture target gases in gas mixtures in which oxygen gas is present without deleterious interference. In an aspect, oxygen gas is present in the gas mixture (e.g., prior to exposure to the electroswing adsorption cell) at a concentration of greater than or equal to 0 vol %, or greater than or equal to 0.1 vol %, or greater than or equal to 1 vol %, or greater than or equal to 2 vol %, or greater than or equal to 5 vol %, or greater than or equal to 10 vol %, or greater than or equal to 20 vol %, or greater than or equal to 50 vol %, or greater than or equal to 75 vol %, or greater than or equal to 90 vol %, greater than or equal to 95 vol %. In an aspect, oxygen gas is present in the gas mixture at a concentration of less than or equal to 99 vol %, or less than or equal to 95 vol %, or less than or equal to 90 vol %, or less than or equal to 75 vol %, or less than or equal to 50 vol %, or less than or equal to 25 vol %, or less than or equal to 21 vol %, or less than or equal to 10 vol %, or less than or equal to 5 vol %, or less than or equal to 2 vol %.

In an aspect, the gas mixture comprises water vapor. The gas mixture can comprise water vapor for example, because it is or comprises ambient air or ventilated air. In an aspect, the gas mixture (e.g., prior to exposure to the electroswing adsorption cell) has a relatively high relative humidity. For example, in an aspect, the gas mixture can have a relative humidity of greater than or equal to 0%, or greater than or equal to 5%, or greater than or equal to 10%, or greater than or equal to 25%, or greater than or equal to 50%, or greater than or equal to 75%, or greater than or equal to 90% at at least one temperature in the range of −50 to 140° C. In an aspect, the gas mixture can have a relative humidity of less than or equal to 100%, or less than or equal to 95%, or less than or equal to 90%, or less than or equal to 75%, or less than or equal to 50%, or less than or equal to 25%, or less than or equal to 10% at at least one temperature in the range of −50 to 140° C.

The target gas can be separated from the gas mixture in the gas separation system by applying a potential difference across the electroswing adsorption cells of the gas separation system. One of ordinary skill, with the benefit of this disclosure, would understand how to apply a potential across the electroswing adsorption cell. For example, the potential can be applied by connecting the negative electrode and the positive electrode to a suitable power source capable of polarizing the negative and positive electrodes. In an aspect the power supply can be a DC voltage. Nonlimiting examples of a suitable power source include batteries, power grids, regenerative power supplies (e.g., wind power generators, photovoltaic cells, tidal energy generators), generators, and the like, and combinations thereof.

The potential difference can be applied to the electroswing adsorption cells during at least a portion of the time that a gas mixture is exposed to the electroswing adsorption cell. In an aspect, the potential difference can be applied prior to exposing the gas mixture to the electroswing adsorption cell.

Application of a positive voltage to the electroswing adsorption cell, during a charging mode, results in a redox reaction at the negative electrode wherein the electroactive species is reduced. As discussed herein, the electroactive species is selected for having a higher affinity for the target gas when it is in a reduced state relative to when it is in an oxidized state. By reducing the electroactive species and passing a gas mixture across the first electrode, the target gas can bond to the electroactive species. In this way the target gas can be removed from the gas mixture to provide a treated gas mixture (e.g., comprising a lesser amount of the target gas relative to the initial gas mixture).

The potential difference applied across the electroswing adsorption cell, during the charge mode, can have a particular voltage. The potential difference applied across the electroswing adsorption cell can depend, for example, on the reduction potential for the generation of at least one reduced state of the first electroactive species, as well as the standard potential for the interconversion between a reduced state and an oxidized state of the electroactive species in the second electrode. The voltage further includes the current multiplied by the stack electrochemical resistance. In an aspect, the potential difference is at least 0 V, or at least 0.1 V, or at least 0.2 V, or at least 0.5 V, or at least 0.8 V, or at least 1.0 V, or at least 1.5 V. In an aspect, the potential difference is less than or equal to 2.0 V, or less than or equal to 1.5 V, or less than or equal to 0.5 V, or less than or equal to 0.2 V.

In an aspect, when the electroactive species of the first electrode comprises a quinone, the electroactive species can be reduced to at least one of its reduced states:

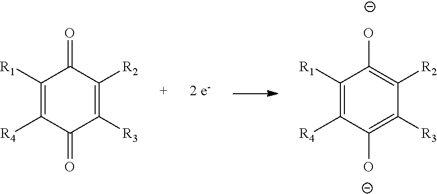

In an aspect, when the electroactive species of the first electrode comprises a quinone and the electroactive species is reduced in the presence of a target gas, for example carbon dioxide, the reduced form of the electroactive species can bond with the carbon dioxide:

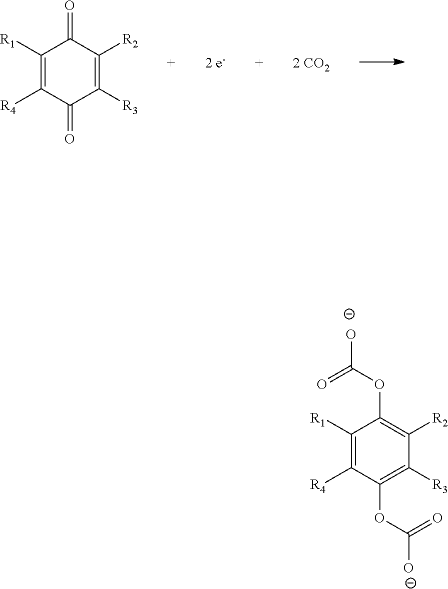

In an aspect, while the electroactive species is reduced at the first electrode, a second electroactive species (e.g., a redox active polymer such as polyvinyl ferrocene) is being oxidized at the second electrode. During the charge mode, the oxidation of the second electroactive species provides a source of electrons for driving the reduction of the first electroactive species.

While the exemplary reactions shown above are shown taking place in one direction, it will be understood that some reversibility can be exhibited. Analogous reaction can take place with different electroactive species, as would be understood by a person of ordinary skill in the art.

In an aspect, a relatively large amount of the target gas is removed from the gas mixture during the processes described herein. Removing a relatively large amount of the target gas can, in some cases, be beneficial for any of a variety of applications, such as capturing gases that can be deleterious if released into the atmosphere for environmental reasons. For example, the target gas can comprise carbon dioxide, and removing a relatively high amount of the carbon dioxide from gas mixture can be beneficial to either limit the greenhouse gas impact of a process (e.g., an industrial process or transportation process) or to even reduce the amount of carbon dioxide in a room or the atmosphere (either for thermodynamic reasons for heating and air conditioning processes or for environmental reasons).

In an aspect, a second potential difference can be applied across the electroswing adsorption cell after at least a portion of the target gas is bonded to the electroactive species. The second potential difference can be different than that first potential difference. In an aspect, applying the second potential difference results in a step of releasing a portion or all of the target gas bonded with the electroactive species to produce a second treated gas mixture. The second treated gas mixture can have a higher amount of the target gas than the input gas mixture. For example, target gas may be present in the second treated gas mixture in an amount such that its volume percent is 10% higher, 20%, higher 50%, 100% higher, 200% higher, 1000% higher, and/or up to 2,000% higher, 5,000% higher, 10,000% higher, or more than the first amount of gas mixture.

The gas separation system can comprise an external circuit connecting the negative electrode and the positive electrode of each electroswing adsorption cell to a power source configured to apply a potential difference across the negative electrode and the positive electrode of each electroswing adsorption cell. Each of the electroswing adsorption cells of the gas separation system can be as described above. The electroswing adsorption cells of the gas separation system can be stacked according to various configurations that are generally known in the art, including parallel or in series.

In an aspect, a gas separation system comprises a first set of electroswing adsorption cells and a second set of electroswing adsorption cells. Each of the first set and the second set can comprise one or more electroswing adsorption cells as described throughout this disclosure. The first and second set can be made to run in parallel in an alternating fashion, such that one set of cells is operating in a charge mode and capturing a target gas (e.g., CO₂) from a gas mixture while another set of cells is operating in a discharge mode and releasing the target gas (e.g., CO₂). The system can comprise separate housings for each of the sets of electroswing adsorption cells. The system can further comprise conduits and valving arranged to direct flow in a desired manner. The gas separation system can allow for nearly continuous separation of a gas mixture (e.g., gas stream), with the gas mixture being directed to the set of cells operating in a charge/capture mode, at a given moment, while a separate target gas-rich treated mixture is produced by the other set of cells operating in a discharge/release mode. Furthermore, additional sets of electroswing adsorption cells may be added in parallel or in series, according to the needs of the application.

The gas mixture (e.g., a gas stream such as an input gas stream) can be introduced to the gas separation system at a particular flow rate. In an aspect, the flow rate can be greater than or equal to 0.001 L/s, greater than or equal to 0.005 L/s greater than or equal to 0.01, greater than or equal to 0.05 L/s, greater than or equal to 0.1 L/s, greater than or equal to 0.5 L/s, greater than or equal to 1 L/s, greater than or equal to 5 L/s, greater than or equal to 10 L/s, greater than or equal to 10 50 L/s, or greater than or equal to 100 L/s. In an aspect, the flow rate of the gas mixture (e.g., a gas stream such as an input gas stream) can be less than or equal to 500 L/s, less than or equal to 400 L/s, less than or equal to 300 L/s, less than or equal to 200 L/s, less than or equal to 100 L/s, less than or equal to 50 L/s, less than or equal to 10 L/s, less than or equal to 1 L/s, less than or equal to 0.5 L/s, or less than or equal to 0.1 L/s.

In an aspect, during or after the step of releasing the target gas, the method further comprises applying a vacuum condition to the electroswing adsorption cell to remove at least a portion or all of the released target gas from the electroswing adsorption cell. One of ordinary skill, with the benefit of this disclosure, would understand suitable techniques and equipment for applying a vacuum condition to the electroswing adsorption cell. For example, a vacuum pump can be fluidically connected to a gas outlet of the electroswing adsorption cell. The vacuum pump can be operated to produce a negative pressure differential between the electroswing adsorption cell bed and a downstream location. This vacuum condition can provide a force sufficient to cause target gas released during the releasing step described above to flow out of the electroswing adsorption cell. The vacuum condition can be applied such that the pressure inside the electroswing adsorption cell during or after the releasing of the target gas is less than or equal to 760 torr, less than or equal to 700 torr, less than or equal to 500 torr, less than or equal to 100 torr, less than or equal to 50 torr, less than or equal to 10 torr, and/or as low as 5 torr, as low as 1 torr, as low as 0.5 torr, as low as 0.1 torr.

In an aspect, the composite of the first electrode has a particular capacity for absorbing target gas (e.g., CO₂). For example, the composite can have an absorption capacity of at least 0.01 moles per square meter (mol/m²), at least 0.02 mol/m², at least 0.05 mol/m², or more. In an aspect, the composite can have an absorption capacity of less than or equal to 0.2 mol/m², less than or equal to 0.08 mol/m², less than or equal to 0.05 mol/m², less than or equal to 0.03 mol/m², or less. For example, the composite can have an absorption capacity of at least 0.01 mol/m² and less than or equal to 0.2 mol/m², or at least 0.02 mol/m² and less than or equal to 0.08 mol/m².

In an aspect the composite of the first electrode can have a particular surface area that is exposed to the gas mixture, for example, of greater than or equal to 5 cm², greater than or equal to 8 cm², greater than or equal to 10 cm², or up to 100 cm², up to 400 cm², or more.

Various components of a system, such as the electrodes (e.g., negative electrode, positive electrodes), power source, electrolyte, separator, container, circuitry, insulating material, and the like can be fabricated by those of ordinary skill in the art from any of a variety of components. Components can be molded, machined, extruded, pressed, isopressed, printed, infiltrated, coated, in green or fired states, or formed by any other suitable technique.

The electrodes described herein (e.g., negative electrode, positive electrodes) can be of any suitable size or shape. Non-limiting examples of shapes include sheets, cubes, cylinders, hollow tubes, spheres, and the like. The electrodes may be of any suitable size, depending on the application for which they are used (e.g., separating gases from ventilated air, direct air capture, etc.). Additionally, the electrode can comprise a means to connect the electrode to another electrode, a power source, and/or another electrical device. Those of ordinary skill in the art are readily aware of techniques for forming components of the system herein.

Various electrical components of the system may be in electrical communication with at least one other electrical component by a means for connecting. A means for connecting can be any material that allows the flow of electricity to occur between a first component and a second component. A non-limiting example of a means for connecting two electrical components is a wire comprising a conductive material (e.g., copper, silver, etc.). In an aspect, the system can comprise electrical connectors between two or more components (e.g., a wire and an electrode). In an aspect, a wire, electrical connector, or other means for connecting can be selected such that the resistance of the material is low. In an aspect, the resistances can be substantially less than the resistance of the electrodes, electrolyte, or other components of the system.

The electroswing adsorption cells, systems, and methods described herein can be implemented in a variety of applications. The following aspects provide several non-limiting examples of applications. In an aspect, the systems and methods described herein can be for removing a target gas (e.g., CO₂) from ambient air, as well as enclosed spaces such as airtight building, car cabins—reducing the heating cost of incoming air for ventilation—and submarines and space capsules, where an increase in CO₂ levels could be catastrophic. In aspects directed to the electrical power industry, they can be used for capturing carbon dioxide post—combustion at varying concentrations. In an aspect, the systems and methods are suitable for separate target gases from industrial flue gas or industrial process gas. Also, they can be used for capturing sulfur dioxide and other gases from flue gas. In aspects directed to the oil and gas industry, the disclosed systems and methods can be used for capturing carbon dioxide and other gases from various processes and diverting them for downstream compression or processing. The disclosed systems and methods can be applied to capture carbon dioxide from burning natural gas used to heat the greenhouses in mild and cold climates, then diverting the captured dioxide into the greenhouse for the plants to use in photosynthesis, i.e., to feed the plants.

Thus, the electroswing adsorption cells including a patterned electrode represent a significant improvement, particularly with regard to improved gas separation systems.

### EXAMPLES

### Example 1: Simulated CO₂ Adsorption by an Electroswing Adsorption Cell with a Pleated Electrode

An active layer comprises 25 volume percent (vol %) carbon nanotubes, 10 vol % poly(phenylnaphthoquinone) (PPNQ) disposed on the surfaces of the carbon nanotubes, and 65 volume % gel electrolyte. The electrolyte comprises 1-butyl-3-methylimidazolium bis(trifluoromethylsulfonyl)imide (BMIM-TFSI) ionic liquid. The electrolyte further comprises poly(ethylene glycol) diacrylate (PEGDA) as gel-former to immobilize the ionic liquid. The mass ratio of BMIM-TFSI to PEGDA is 90:10. The carbon nanotubes are in the form of a mat, such as MIRALON™ commercially available from Nanocomp Technologies, Inc. The active layer thickness is 2 micrometers.

A second layer of nanotube mat with pores filled with air is placed on the active layer. The thickness of this spacer layer is 2 micrometers, and it has a gas volume fraction of 70 vol %. The active layer and gas layer are pleated together. The pleat height (e.g., L_{I} in FIG. 12) is 150 micrometers. The pleated electrode is placed on a microporous polypropylene separator which is 16 microns thick and has a porosity of about 40 vol %. A counter-electrode comprising carbon nanotubes and poly(vinyl ferrocene) is placed on the opposite side of the separator. The pores of the separator and the counter electrode are filled with the electrolyte comprising BMIM-TFSI and PEGDA.

The performance of the cell of Example 1 adsorbing CO₂ from flowing air at room temperature was simulated. In the simulation, the concentration of CO₂ in both the gas phase and dissolved into the electrolyte phase is understood to be governed by Fick's law of diffusion. The CO₂ concentration in the electrolyte at the interface between the electrolyte and the gas phase is assumed to be in equilibrium with the gas phase. Application of a cathodic potential to the adsorbent electrode drives electrochemical current which results in reduction of the adsorbent material. The current distribution is modeled with porous electrode theory. Because the ratio of kinetic resistance to ionic and electronic resistance is greater than 1, the reaction-rate distribution is fairly uniform across the active layer. The reduced material can adsorb CO₂ from the electrolyte, thereby reducing the concentration of CO₂ in the electrolyte, which drives dissolution of CO₂ from the gas into the electrolyte. The adsorption kinetics are sufficiently fast relative to the rate of CO₂ diffusion so that reduced adsorbent quickly adsorbs CO₂ if the CO₂ concentration in the neighboring electrolyte is above zero. Gas enters the system from a gas inlet channel, transports via diffusion and convection through the gas-diffusion layer and gas regions, reacts via dissolution into the electrolyte phase, and exits through a gas outlet channel. The 2-D simulations were carried out using the COMSOL Multiphysics software. The diffusivity of CO₂ in the BMIM-TFSI electrolyte was 6.4e-10 m²/s as measured according to Ying Hou and Ruth E. Baltus, Ind. Eng. Chem. Res. 2007 vol. 46, no. 24 p. 8166-8175, “Experimental Measurement of the solubility and diffusivity of CO₂ in room-temperature ionic liquids using a transient thin-liquid-film method”), the content of which is incorporated herein by reference in its entirety. The diffusivity in the pure electrolyte is multiplied by (electrolyte volume fraction)^{1.5} to estimate the effective diffusivity in the active composite, as predicted by the Bruggeman relation. The Henry's law constant for the equilibrium concentration of CO₂ in BMIM-TFSI was 29 bar as measured according to Javid Safarov, Rena Hamidova, Martin Stephan, Norbert Schmotz, Ismail Kul, Astan Shahverdiyev, and Egon Hassel, J Chem Therm 2013 vol. 67 p. 181-189, “Carbon dioxide solubility in 1-butyl-3-methylimidazolium-bis(trifluormethylsulfonyl)imide over a wide range of temperatures and pressures”, the content of which is incorporated herein by reference in its entirety. The diffusivity of CO₂ in air is 1.6×10⁻⁵ m²/s. The inlet mole fraction of CO₂ was 400 ppm and the inlet pressure was 1 bar. The inlet flow rate of CO₂ is twice the amount of CO₂ consumed by reaction, with the result that the outlet concentration of CO₂ is half that of the inlet concentration.

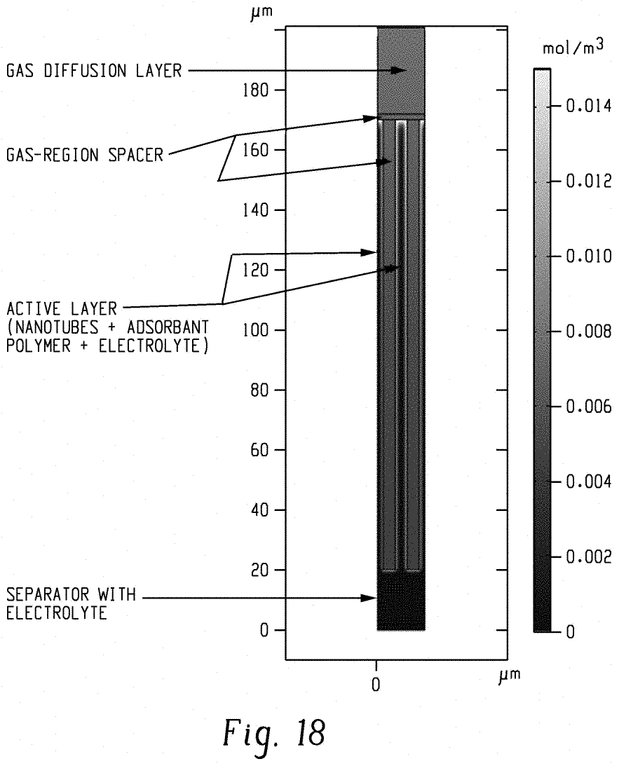

FIG. 18 shows the concentration of CO₂ in both the electrolyte and gas phases in the active region; the counter electrode, flowfield channels, and most of the gas diffusion layer are not shown for clarity. The gas-phase CO₂ concentration is 0.0075 mol/m³ in the gas diffusion layer adjacent to the pleated electrode, and falls below 0.0046 mol/m³ in the gas region closest to the separator. As a result of the lower CO₂ concentration in the gas region, the CO₂ dissolution into the electrolyte is reduced, which limits utilization of the active material in the bottom of the pleat.

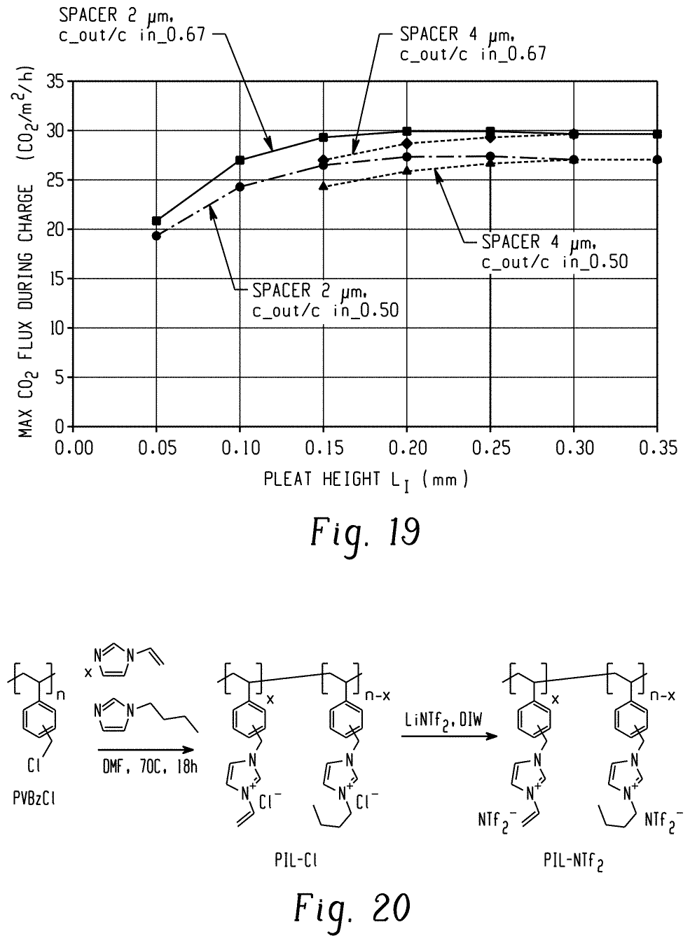

FIG. 19 shows the maximum flux of CO₂ (in grams of CO₂ per apparent area per hour of charge time, gCO₂/m²/h_{charge}) simulated for different pleat heights, thicknesses of the spacer layer, and outlet concentrations (which is determined by the gas flow rate relative to the applied current), for inlet gas with the composition of typical ambient air (400 ppm CO₂, 20° C.). For pleat heights below 150 micrometers, the flux is primarily limited by diffusion of CO₂ within the electrolyte across the 2 micrometer-thick active layer. Increasing the pleat height enables higher flux by spreading out the CO₂ transport across a larger area of electrolyte. Above 150 micrometers, there is no further increase in flux with increasing pleat height. While not wanting to be bound by theory, it is understood that flux does not further increase because gas-phase diffusion is limiting performance, consistent with the results shown in FIG. 18. Also, the gas-phase concentration in the bottom of the pleat is driven so low by diffusion that the adsorbent material more than 150 micrometers away from the gas diffusion layer is not effectively utilized.

### Comparative Example 1: Evaluation of CO₂ Flux with PPNQ-CNT Mat Composite Electrodes

Poly(phenylnaphthoquinone) (PPNQ) was dissolved in tetrahydrofuran at concentration of 10 milligrams per milliliter. A 15-micrometer-thick carbon nanotube (CNT) mat, Miralon™, commercially available from Nanocomp Technologies, Inc., was submerged in the solutions of PPNQ in sealed vials and allowed to sit at room temperature for 1 to 72 hours. The mat samples were then removed from the vials, rinsed using the same solvent that was used for the soaking process, and then dried under reduced pressure at a temperature of 60-80° C. for at least 12 hours. The mass of the CNT mat pieces after submersion in the polymer solution was compared to the initial mass of the bare CNT mat. For each solution, the amount of PPNQ was about 0.1 mg/cm², for example 0.1 to 0.5 milligrams of polymer per square inch of CNT mat. The PPNQ-CNT mat composite electrodes were then cut into 1.98 cm² disks and assembled into cells with poly(vinyl ferrocene)-nanotube counter electrode, Celgard 3401 separator, and gCO₂/m²/h_{charge}-TFSI electrolyte filling the pores of the electrodes and separator. In this planar geometry, with no gas regions in the electrode, the flux of CO₂ was 0.2 gCO₂/m²/h_{charge} with room temperature flowing air.

### Synthesis Example 1: Preparation of a Polymeric Ionic Liquid

A polymeric ionic liquid was synthesized as shown in FIG. 20 and according to the following procedure. Polyvinylbenzylchloride (PVBzCl) (10 g, Mw 100 kDa) was dissolved in DMF (50 mL) and the solution was heated to 80° C. To this was added N-vinylimidazole (0.93 g) and the contents were stirred for 18 hours. Then, N-butylimidazole (8.14 g) was added and the contents were stirred for an additional 18 hours. After cooling to room temperature, the polymer was precipitated from excess ethyl acetate to obtain PIL-Cl. PIL-Cl was dissolved in deionized water and precipitated from an aqueous solution of LiNTf₂ (2× molar equivalent). This process was repeated once more. The isolated polymer was extensively washed with deionized water and dried in a vacuum oven at 50° C. for 24 hours to yield PIL-NTf₂ having 15 mole percent vinyl content.

### Synthesis Example 2: Preparation of a Polymeric Ionic Liquid

A polymeric ionic liquid was synthesized according to the procedure of synthesis example 1 except that the amount of N-vinylimidazole was 1.54 g and the amount of N-butyl imidazole was 8.14 g, providing the PIL-NTf₂ polymer having 25 mole percent vinyl content.

### Comparative Example 2: Preparation of a Non-Patterned Electrode

Multi-walled carbon nanotubes (MWCNT) (2.4 g), 0.24 g PPNQ and 2 mL THF were combined in a glass vial and mixed with a rotor/stator (IKA) for 20 minutes two times at 15,000 rpm. Separately, 0.86 g of the polymeric ionic liquid of synthesis example 2 was dissolved in 4 mL THF, to which solution was added 0.46 g of polyethylene glycol (PEG) molecular weight 400, and 0.71 g BMIM TFSI ionic liquid. This solution was combined with the MWCNT/PPNQ dispersion, and 0.27 g of water was added. The material was coated on 28BC with a 10 mil drawdown bar (BYK Gardiner) and allowed to dry. Half of the coating was dried in a vacuum oven.

### Example 2: Preparation of a Patterned Electrode

The coating of comparative example 2 was soaked in water for 3 hours, dried in ambient conditions and then in a vacuum oven overnight.

To evaluate flux of the non-patterned and patterned electrodes of comparative example 2 and example 2, respectively, the electrodes were subjected to galvanostatic and potentiostatic analysis in a sealed testing apparatus. The working electrode was assembled in a 2 cm² electrochemical cell with a counter electrode made with 3.8 mg polyvinylferrocene, two layers of Celgard 3401 separator and a total 60 μL BMIM TFSI electrolyte. Each electrochemical cell was enclosed in a sealed apparatus of 6.5 cm³ internal volume and fitted with a pressure transducer. The apparatus was stored, and the entire experiment was carried out in an environment chamber with a fixed temperature of 25° C. Capture of CO₂ was evaluated by pressure drop at three CO₂ concentrations (1%, 10% and 100% of CO₂ in N₂).

As shown in Table 1, soaking in water to provide the patterned electrode of example 2 facilitated the removal of the polyethylene glycol and led to higher CO₂ flux values relative to the coating of comparative example 2. Without wishing to be bound by theory, it is believed that the removal of the polyethylene glycol allows for formation of gas regions, thereby improving the flux.

TABLE 1

| | Flux(gCO₂/ | Flux(gCO₂/ | Flux(gCO₂/ |
|---|---|---|---|
| | m²/h_{charge)}, | m²/h_{charge)}, | m²/h_{charge)}, |
| | 1% CO₂ in N₂ | 10% CO₂ in N₂ | 100% CO₂ |
| Comparative | 2.0 | 4.5 | 5.0 |
| Example 2 | | | |
| Example 2 | 3.1 | 4.8 | 5.9 |

### Comparative Example 3: Preparation of a Non-Patterned Electrode

Multi-walled carbon nanotubes (MWCNT) (0.275 g), 0.0688 g PPNQ and 2 g MEK were combined in a glass vial and mixed with a rotor/stator (IKA) for 20 minutes two times at 15,000 rpm. Separately, 0.275 g of the polymeric ionic liquid of synthesis example 1 was dissolved in 4 mL MEK, to which solution was added 0.6 g of polyethylene glycol (PEG) molecular weight 400, and 0.22 g BMIM TFSI ionic liquid. This solution was combined with the MWCNT/PPNQ dispersion, and 0.27 g of water was added. The material was coated on 28BC with a 10 mil drawdown bar (BYK Gardiner) and allowed to dry. Half of the coating was dried in a vacuum oven.

### Example 3: Preparation of a Patterned Electrode

The coating of comparative example 3 was soaked in water for 4 hours, dried in ambient conditions and then in a vacuum oven overnight.

To evaluate flux of the non-patterned and patterned electrodes of comparative example 3 and example 3, respectively, the electrodes were each subjected to galvanostatic and potentiostatic analysis in a sealed testing apparatus. The working electrode was assembled in a 2 cm² electrochemical cell with a counter electrode made with 3.8 mg polyvinylferrocene, two layers of Celgard 3401 separator and a total of 60 μL BMIM TFSI electrolyte. The electrochemical cell was enclosed in a sealed apparatus of 6.5 cm³ internal volume and fitted with a pressure transducer. The apparatus was stored, and the entire experiment was carried out in an environment chamber with a fixed temperature of 25° C. Capture of CO₂ was evaluated by pressure drop at three CO₂ concentrations (1%, 10% and 100% of CO₂ in N₂), and the flux is reported in units of gCO₂/m²/h_{charge}.

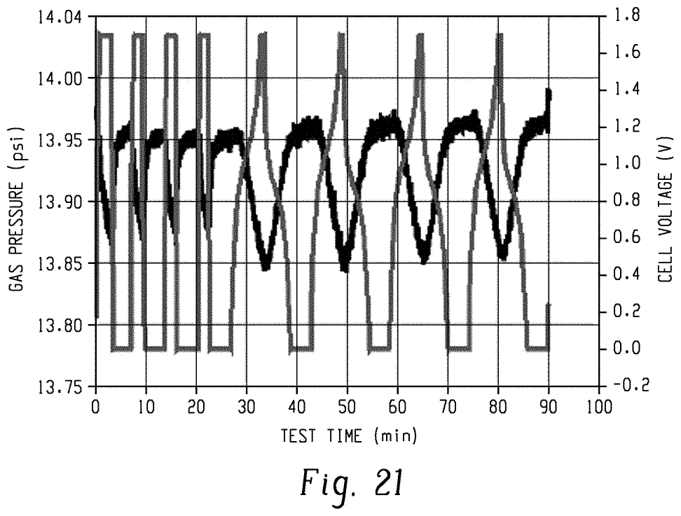

As shown in Table 2, soaking in water to provide the patterned electrode of example 3 facilitated the removal of the polyethylene glycol and led to higher CO₂ flux values relative to the coating of comparative example 3. Without wishing to be bound by theory, it is believed that the removal of the polyethylene glycol allows for formation of gas regions, thereby improving the flux at 10% and 100% CO₂. FIG. 21 shows a graph of pressure drop and cell voltage vs. time for the electroswing adsorption cell including the patterned electrode of example 3 at 10% CO₂ in N₂. The decrease in the pressure over time is indicative of CO₂ capture in the electroswing adsorption cell.

TABLE 2

| | Flux(gCO₂/ | Flux(gCO₂/ | Flux(gCO₂/ |
|---|---|---|---|
| | m²/h_{charge)}, | m²/h_{charge)}, | m²/h_{charge)}, |
| | 1% CO₂ in N₂ | 10% CO₂ in N₂ | 100% CO₂ |
| Comparative | 4.8 | 7.4 | 16.8 |
| Example 3 | | | |
| Example 3 | 4.4 | 8.5 | 18.7 |

### Comparative Example 4: Preparation of a Non-Patterned Electrode

LITX™ 300 (Cabot Corp.) (0.6 g), 0.15 g PPNQ and 4 mL THF were combined in a glass vial and mixed with a rotor/stator (IKA) for 20 minutes two times at 15,000 rpm. Separately, 0.6 g polymeric ionic liquid of synthesis example 2 was dissolved in 4 mL THF, to which solution was added 1.2 g of polyethylene glycol (PEG) molecular weight 400, and 0.48 g BMIM TFSI ionic liquid. This solution was combined with the LITX™ 300/PPNQ dispersion, and 0.27 g of water were added. The material was coated on a Miralon™ carbon fiber mat (Huntsman Corp) with a 10 mil drawdown bar (BYK Gardiner) and allowed to dry. Half of the coating was dried in a vacuum oven.

### Example 4: Preparation of a Patterned Electrode

The coating of comparative example 4 was soaked in water for 6 hours, dried in ambient conditions and then in a vacuum oven overnight.

Flux was evaluated as described in previous examples. As shown in Table 3, soaking in water facilitated the removal of the polyethylene glycol to provide the patterned electrode of example 4 and led to higher CO₂ flux values relative to the coating of comparative example 4. Without wishing to be bound by theory, it is believed that the removal of the polyethylene glycol allows for formation of gas regions, thereby improving the flux at 1%, 10% and 100% CO₂.

TABLE 3

| | Flux(gCO₂/ | Flux(gCO₂/ | Flux(gCO₂/ |
|---|---|---|---|
| | m²/h_{charge)}, | m²/h_{charge)}, | m²/h_{charge)}, |
| | 1% CO₂ in N₂ | 10% CO₂ in N₂ | 100% CO₂ |
| Comparative | 4.1 | 13.6 | 39.6 |
| Example 4 | | | |
| Example 4 | 10.6 | 20.0 | 42.9 |

### Comparative Example 5: Preparation of a Non-Patterned Electrode

Polymeric ionic liquid of synthesis example 1 (1.2 grams) was dissolved in MEK (18 grams). To this solution, MWCNT (1.2 grams) and PPNQ (0.3 grams) were added. The resulting mixture was subjected to shear using a rotor/stator (IKA) for 20 minutes, two times each at 20,000 rpm, followed by sonication for 40 minutes. BMIM TFSI (0.96 grams) was added to the mixture, and stirred for 20 minutes. The mixture was coated on a MIRALON substrate with a 20 mil drawdown bar (BYK Gardiner) and allowed to dry.

### Example 5: Preparation of a Patterned Electrode

The patterned electrode was prepared according to the same procedure as comparative example 5, except that sodium Y zeolite (2.4 grams) was added to the material prior to forming the coating.

CO₂ flux was evaluated as described in previous examples. Flux for the patterned electrode of example 5 containing the zeolite particles was found to be higher at low CO₂ concentrations (e.g., 1% CO₂) relative to the flux for comparative example 5. The flux was observed to be the same as that of comparative example 5 for higher CO₂ concentrations (e.g., 10% and 100%). The flux for example 5 and comparative example 5 at 1, 10 and 100% CO₂ is provided in Table 4.

TABLE 4

| | Flux(gCO₂/ | Flux(gCO₂/ | Flux(gCO₂/ |
|---|---|---|---|
| | m²/h_{charge)}, | m²/h_{charge)}, | m²/h_{charge)}, |
| | 1% CO₂ in N₂ | 10% CO₂ in N₂ | 100% CO₂ |
| Comparative | 8.5 | 27.5 | 49.8 |
| Example 5 | | | |
| Example 5 | 12.3 | 25.8 | 48.9 |

The present disclosure further encompasses the following non-limiting aspects.

Aspect 1: A patterned electrode for an electroswing adsorption cell comprising: a plurality of electrolyte regions, a plurality of gas regions, and a conductive scaffold, the conductive scaffold extending into the plurality of electrolyte regions and including an electroactive species capable of bonding with a target gas when the electroactive species is in a reduced state and releasing the target gas when the electroactive species is in an oxidized state.

Aspect 2: The patterned electrode of aspect 1, wherein the first electrode has a thickness of 15 to 500 micrometers.

Aspect 3: The patterned electrode of aspect 1 or 2, wherein a diffusion length of a target gas species through the electrolyte region to an active site in the patterned electrode is 1 μm to 1 mm.

Aspect 4: The patterned electrode of any of aspects 1 to 3, wherein the plurality of electrolyte regions and the plurality of gas regions form a regular pattern.

Aspect 5: The patterned electrode of any of aspects 1 to 3, wherein the plurality of gas regions are dispersed randomly throughout the electrode.

Aspect 6: The patterned electrode of any of aspects 1 to 5, wherein the plurality of gas regions have a dimension that is 1 to 100 micrometers.

Aspect 7: The patterned electrode of any of aspects 1 to 6, wherein the gas regions comprise zeolite particles.

Aspect 8: The patterned electrode of aspect 7, wherein the zeolite particles have an average diameter of 1 to 100 micrometers.

Aspect 9: The patterned electrode of aspect 7 or 8, wherein the zeolite particles are synthetic zeolites, preferably zeolite A, zeolite X, zeolite Y, zeolite L or a combination thereof, more preferably zeolite Y.

Aspect 10: The patterned electrode of any of aspects 1 to 9, wherein the first electrode has a pleated or folded configuration.

Aspect 11: The patterned electrode of any of aspects 1 to 10, wherein the electrode comprises two or more layers.

Aspect 12: The patterned electrode of any of aspects 1 to 11, wherein the conductive scaffold extends into the plurality of gas regions.

Aspect 13: The patterned electrode of any of aspects 1 to 12, wherein each of the plurality of gas regions have an average diameter and are separated by an average distance, and the ratio of the average diameter to the average distance is 0.01 to 0.5.

Aspect 14: The patterned electrode of any of aspects 1 to 13, wherein the electrolyte region comprises an electrolyte comprising an ionic liquid.

Aspect 15: The patterned electrode of any of aspects 1 to 14, wherein the electrolyte region comprises an electrolyte comprising a gel or a polymer.

Aspect 16: The patterned electrode of any of aspects 1 to 15, wherein the conductive scaffold in the electrolyte regions or the conductive scaffold in the gas regions comprises a carbon nanotube mat.

Aspect 17: The patterned electrode of any of aspects 1 to 16, wherein the conductive scaffold in the gas regions comprises carbon black and binder.

Aspect 18: The patterned electrode of any of aspects 1 to 17, wherein each of the plurality of electrolyte regions has an average pathlength of 0.5 to 50 micrometers.

Aspect 19: The patterned electrode of any of aspects 1 to 18, wherein the electroactive species comprises an electroactive polymer, an electroactive oligomer, an electroactive organic compound, or a combination thereof.

Aspect 20: The patterned electrode of any of aspects 1 to 19, wherein the electroactive species comprises a substituted or unsubstituted quinone or tetrone, preferably benzoquinone, 1,4-naphthoquinone, 1,2-naphthoquinone, anthraquinone, phenanthrenequinone, benzanthraquinone, dibenzoanthraquinone, 4,5,9,10-pyrenetetrone, or a combination thereof; or a polymer or oligomer comprising repeating units derived from a substituted or unsubstituted quinone or tetrone, preferably a polymer comprising repeating unites derived from benzoquinone, 1,4-naphthoquinone, 1,2-naphthoquinone, anthraquinone, phenanthrenequinone, benzanthraquinone, dibenzoanthraquinone, 4,5,9,10-pyrenetetrone, or a combination thereof.

Aspect 21: An electroswing adsorption cell comprising the patterned electrode of any of aspects 1 to 20; a second electrode comprising a complementary electroactive composite layer; and a separator between the patterned electrode and the second electrode.

Aspect 22: The electroswing adsorption cell of aspect 21, wherein the patterned electrode, the second electrode, and the separator are folded or pleated together.

Aspect 23: The electroswing adsorption cell of aspects 20 or 21, further comprising a gas flowfield adjacent to the pattereed electrode, wherein the gas flowfield comprises flowfield channels.

Aspect 24: The electroswing adsorption cell of aspect 23, wherein the flowfield channels are arranged perpendicular to the gas regions of the first electrode.

Aspect 25: The electroswing adsorption cell of aspect 23 or 24, wherein the gas flowfield has an interdigitated flow pattern.

Aspect 26: The electroswing adsorption cell of aspect 23, wherein the gas flowfield comprises a plurality of ribs, wherein the ribs comprise a compressible, electrically conductive, and impermeable material.

Aspect 27: A method of producing the electrode for an electroswing adsorption cell of any of aspects 1 to 20, the method comprising: depositing a composite material onto a separator, the composite material comprising an electrolyte and the conductive scaffold coated with the electroactive species; and forming the patterned electrode comprising the plurality of electrolyte regions and the plurality of gas regions; wherein forming the patterned electrode is by machining, lithography, etching, self-assembly, removal of a porogen or a combination thereof.

Aspect 28: The method of aspect 27, wherein the composite material comprises a porogen capable of being removed by heat or extraction with a solvent.

Aspect 29: A method of producing an electroswing adsorption cell, the method comprising: depositing a composite material onto a separator, the composite material comprising an electrolyte and a conductive scaffold coated with an electroactive species; forming a patterned first electrode comprising a plurality of electrolyte regions and a plurality of gas regions; and coupling a gas flowfield and a second electrode to the patterned first electrode to provide the electroswing adsorption cell.

Aspect 30: The method of aspect 29, wherein forming the first patterned electrode comprises removing a portion of the composite material to form the plurality of electrolyte regions and the plurality of gas regions, wherein removing the portion of the composite material is by laser ablation, lithography, mechanical impression, machining, etching, removal of a porogen or a combination thereof.

Aspect 31: A method of producing an electroswing adsorption cell, the method comprising: providing a composite layer comprising an electrolyte and a first conductive scaffold coated with an electroactive species; providing a second conductive scaffold comprising gas-filled pores; pleating the composite layer with the second composite layer to provide a patterned first electrode; and coupling a gas flowfield and a second electrode to the patterned first electrode to provide the electroswing adsorption cell.

Aspect 32: A gas separation system comprising a plurality of electroswing adsorption cells in fluid communication with a gas inlet and a gas outlet, wherein each of the plurality of electroswing adsorption cells is according to any of aspects 21 to 26.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modifications are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A patterned electrode for an electroswing adsorption cell comprising:
a plurality of electrolyte regions,
a plurality of gas regions, and
a conductive scaffold, the conductive scaffold extending into the plurality of electrolyte regions and including an electroactive species capable of bonding with a target gas when the electroactive species is in a reduced state and releasing the target gas when the electroactive species is in an oxidized state.

2. The patterned electrode of claim 1, wherein the first electrode has a thickness of 15 to 500 micrometers.

3. The patterned electrode of claim 1, wherein a diffusion length of a target gas species through the electrolyte region to an active site in the patterned electrode is 1 μm to 1 mm.

4. The patterned electrode of claim 1, wherein the plurality of electrolyte regions and the plurality of gas regions form a regular pattern.

5. The patterned electrode of claim 1, wherein the plurality of gas regions are dispersed randomly throughout the electrode.

6. The patterned electrode of claim 1, wherein the plurality of gas regions have a dimension that is 1 to 100 micrometers.

7. The patterned electrode of claim 1, wherein the gas regions comprise zeolite particles, preferably wherein the zeolite particles have an average diameter of 1 to 100 micrometers.

8. The patterned electrode of claim 1, wherein the first electrode has a pleated or folded configuration.

9. The patterned electrode of claim 1, wherein the electrode comprises two or more layers.

10. The patterned electrode of claim 1, wherein the conductive scaffold extends into the plurality of gas regions.

11. The patterned electrode of claim 1, wherein each of the plurality of gas regions have an average diameter and are separated by an average distance, and the ratio of the average diameter to the average distance is 0.01 to 0.5.

12. The patterned electrode of claim 1, wherein the electrolyte region comprises an electrolyte comprising an ionic liquid, a gel electrolyte, a gel polymer electrolyte or a polymer ionic liquid.

13. The patterned electrode of claim 1, wherein each of the plurality of electrolyte regions has an average pathlength of 0.5 to 50 micrometers.

14. The patterned electrode of claim 1, wherein the electroactive species comprises an electroactive polymer, an electroactive oligomer, an electroactive organic compound, or a combination thereof.

15. An electroswing adsorption cell comprising
the patterned electrode of claim 1;
a second electrode comprising a complementary electroactive composite layer; and
a separator between the patterned electrode and the second electrode.

16. The electroswing adsorption cell of claim 15, wherein the patterned electrode, the second electrode, and the separator are folded or pleated together.

17. A method of producing the patterned electrode for an electroswing adsorption cell of claim 1, the method comprising:
depositing a composite material onto a separator, the composite material comprising an electrolyte and the conductive scaffold coated with the electroactive species; and
forming the patterned electrode comprising the plurality of electrolyte regions and the plurality of gas regions;
wherein forming the patterned electrode is by laser ablation, lithography, mechanical impression, machining, etching, removal of a porogen or a combination thereof.

18. A method of producing an electroswing adsorption cell, the method comprising:
depositing a composite material onto a separator, the composite material comprising an electrolyte and a conductive scaffold coated with an electroactive species;
forming a patterned first electrode comprising a plurality of electrolyte regions and a plurality of gas regions; and
coupling a gas flowfield and a second electrode to the patterned first electrode to provide the electroswing adsorption cell;
wherein forming the first patterned electrode comprises removing a portion of the composite material to form the plurality of electrolyte regions and the plurality of gas regions;
wherein removing the portion of the composite material is by laser ablation, lithography, mechanical impression, machining, etching, removal of a porogen or a combination thereof.

19. A method of producing an electroswing adsorption cell, the method comprising:
providing a composite layer comprising an electrolyte and a first conductive scaffold coated with an electroactive species;
providing a second conductive scaffold comprising gas-filled pores;
pleating the composite layer with the second composite layer to provide a patterned first electrode; and
coupling a gas flowfield and a second electrode to the patterned first electrode to provide the electroswing adsorption cell.

20. A gas separation system comprising
a plurality of electroswing adsorption cells in fluid communication with a gas inlet and a gas outlet, wherein each of the plurality of electroswing adsorption cells is according to claim 15.
